(19) United States
(12) Patent Application Publication
(10) Pub. No.: US 2018/0198905 A1
(43) Pub. Date: Jul. 12, 2018

(54) ELECTRONIC APPARATUS AND METHOD OF OPERATING THE SAME

(71) Applicant: SAMSUNG ELECTRONICS CO., LTD., Suwon-si (KR)

(72) Inventors: Young-soo CHOI, Seoul (KR); Young-cheol KANG, Incheon (KR); Sung-sik HAN, Seoul (KR)

(21) Appl. No.: 15/860,970

(22) Filed: Jan. 3, 2018

(30) Foreign Application Priority Data
Jan. 6, 2017 (KR) 10-2017-0002552

(51) Int. Cl. H04M 1/725; A63F 13/30; A63F 13/40; H04B 1/401; H04Q 9/04; G08C 17/02; H04N 21/4147

(52) U.S. Cl. CPC H04M 1/72533; A63F 13/30; A63F 13/40; H04N 21/4147; H04Q 9/04; G08C 17/02; H04B 1/401

(57) ABSTRACT

Provided is an electronic apparatus including a display configured to display a web page, a communicator comprising communication circuitry configured to transmit, to a display apparatus paired with the electronic apparatus, web page information for displaying the web page, a memory storing one or more instructions, and a processor configured to execute the one or more instructions stored in the memory. The processor is further configured, by executing the one or more instructions, to cause the electronic apparatus to: receive content information regarding web content selected from the web page displayed on the display apparatus, determine a control interface corresponding to the web content, based on the content information, and control the display to display the determined control interface.

### CROSS-REFERENCE TO RELATED APPLICATION

This application is based on and claims priority under 35 U.S.C. § 119 to Korean Patent Application No. 10-2017-0002552, filed on Jan. 6, 2017, in the Korean Intellectual Property Office, the disclosure of which is incorporated by reference herein in its entirety.

### BACKGROUND

### 1. Field

The present disclosure relates generally to an electronic apparatus and a method of operating the same, and for example, to an electronic apparatus capable of providing a control interface for controlling web content displayed on a display apparatus, and a method of operating the same.

### 2. Description of Related Art

Display apparatuses are apparatuses having a function of displaying an image which a user may view. Recently, display apparatuses have been provided in the form of smart televisions (TVs) having a broadcasting function and capable of providing various types of content, and may also provide a web browser function.

However, when the web browser function of a display apparatus is executed using a remote control device (e.g., a TV remote control), executing the web browser function is complicated and an input method is inconvenient. Thus, it is not easy to execute the web browser function in the display apparatus. Furthermore, a TV remote control application provided by an external device provides only a power on/off function, a volume control function, a channel switching function, etc., which are basic functions of a TV, and does not provide functions optimized for executing of the web browser function.

### SUMMARY

Various example embodiments provide an electronic apparatus capable of differently providing a control interface based on the type of web content displayed on an external device, and a method of operating the same.

Additional example aspects will be set forth in part in the description which follows and, in part, will be apparent from the description.

According to an aspect of an example embodiment, an electronic apparatus is provided, the electronic apparatus including a display configured to display a web page, a communicator comprising communication circuitry configured to transmit web page information for displaying the web page to a display apparatus paired with the electronic apparatus, a memory storing one or more instructions, and a processor configured to execute the one or more instructions stored in the memory, wherein the processor is further configured, by executing the one or more instructions, to receive content information regarding web content selected from the web page displayed on the display apparatus, determine a control interface corresponding to the web content, based on the content information, and control the display to display the determined control interface.

According to an aspect of another example embodiment, a method of operating an electronic apparatus includes displaying a web page, transmitting web page information for displaying the web page to a display apparatus paired with the electronic apparatus, receiving content information of web content selected from the web page on the display apparatus, and determining and displaying a control interface corresponding to the web content on the basis of the content information.

### BRIEF DESCRIPTION OF THE DRAWINGS

These and/or other aspects, features and attendant advantages of the present disclosure will become apparent and more readily appreciated from the following detailed description, taken in conjunction with the accompanying drawings, in which like reference numerals refer to like elements, and wherein:

FIG. 1 is a diagram illustrating an example electronic apparatus and a display apparatus, according to an example embodiment of the present disclosure;

FIG. 2 is a flowchart illustrating an example method of operating an electronic apparatus, according to an example embodiment of the present disclosure;

FIG. 3 is a flowchart illustrating an example method of operating an electronic apparatus and a display apparatus, according to an example embodiment of the present disclosure;

FIG. 4 is a diagram illustrating an example method by which a web page displayed on an electronic apparatus is displayed on a display apparatus, according to an example embodiment of the present disclosure;

FIGS. 5A and 5B are diagrams illustrating an example method of displaying a control interface when image content is selected, the method performed by an electronic apparatus, according to an example embodiment of the present disclosure;

FIGS. 6A and 6B are diagrams illustrating an example method of displaying a control interface when video content is selected, the method performed by an electronic apparatus, according to an example embodiment of the present disclosure;

FIGS. 7A and 7B are diagrams illustrating an example method of displaying a control interface when audio content is selected, the method performed by an electronic apparatus, according to an example embodiment of the present disclosure;

FIGS. 8A and 8B are diagrams illustrating an example method of displaying a control interface when text content is selected, the method performed by an electronic apparatus, according to an example embodiment of the present disclosure;

FIGS. 9A and 9B are diagrams illustrating an example method of displaying a control interface when game content is selected, the method performed by an electronic apparatus, according to an example embodiment of the present disclosure;

FIGS. 10A and 10B are diagrams illustrating an example method of displaying a control interface when a character input window is selected, the method performed by an electronic apparatus, according to an example embodiment of the present disclosure;

FIGS. 11A, 11B and 11C are diagrams illustrating an example method of selecting web content on the basis of a tab input, the method performed by an electronic apparatus, according to an example embodiment of the present disclosure;

FIGS. 12A, 12B and 12C are diagrams illustrating an example method of controlling a speed of moving a pointer displayed on a display apparatus, according to an example embodiment of the present disclosure;

FIG. 13 is a block diagram illustrating an example electronic apparatus according to an example embodiment of the present disclosure;

FIG. 14 is a block diagram illustrating an example electronic apparatus according to another example embodiment of the present disclosure; and

FIG. 15 is a block diagram illustrating an example display apparatus according to an example embodiment of the present disclosure.

### DETAILED DESCRIPTION

The terms used herein will be briefly described and thereafter the present disclosure will be described in greater detail.

As used herein, general terms that have been widely used are selected, if possible, in consideration of functions of the present disclosure, but non-general terms may be selected according to the intentions of technicians in this art, precedents, or new technologies, etc. Some terms may be arbitrarily chosen. In this case, the meanings of these terms will be explained in corresponding parts of the present disclosure in detail. Thus, the terms used herein should be defined not based on the names thereof but based on the meanings thereof in the whole context of the present disclosure.

It should be understood that the terms “comprise” and/or “comprising,” when used herein, specify the presence of stated elements, but do not preclude the presence or addition of one or more other elements. The terms “unit”, “module”, etc., when used herein, represent units which perform at least one function or operation and which may be embodied by hardware, software, of any combination thereof.

Embodiments will be described in detail below with reference to the accompanying drawings so that those of ordinary skill in the art can easily implement them. However, the present disclosure may be embodied in many different forms and are not limited by embodiments set forth herein. For clarity, parts of the present disclosure which are not related to clearly describing the present disclosure may be omitted in the drawings. Throughout the detailed description, the same reference numerals denote the same elements.

As used herein, the term “and/or” includes any and all combinations of one or more of the associated listed items. Expressions such as “at least one of,” when preceding a list of elements, modify the entire list of elements and do not modify the individual elements of the list.

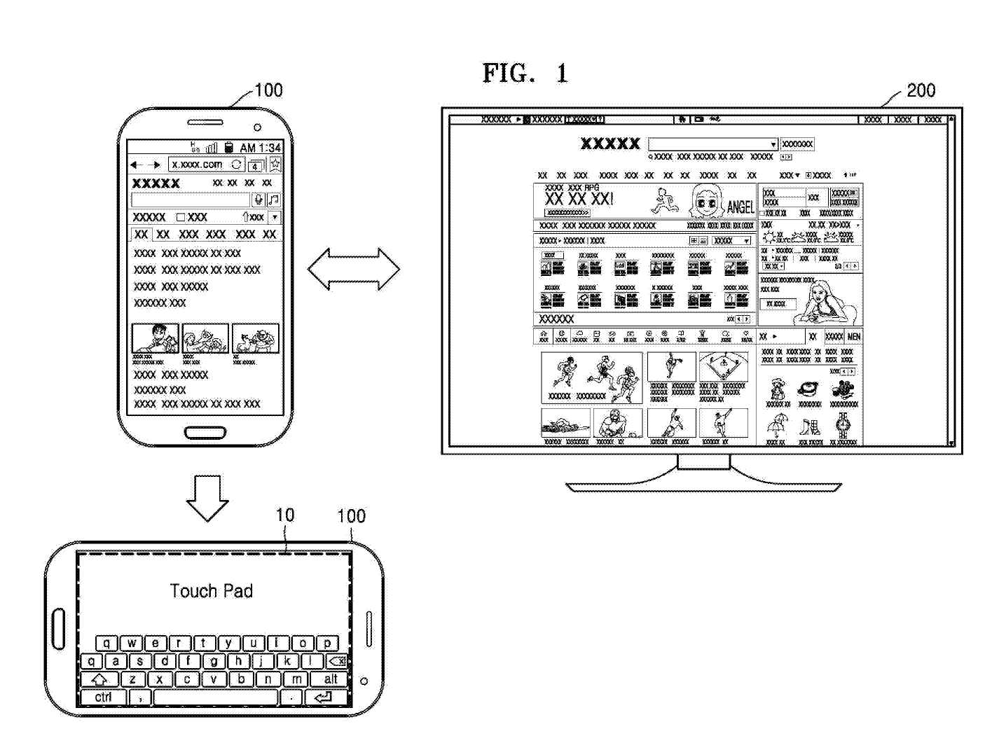

FIG. 1 is a diagram illustrating an example electronic apparatus 100 and a display apparatus 200 according to an example embodiment of the present disclosure.

According to an example embodiment, the electronic apparatus 100 may be embodied in various forms. For example, the electronic apparatus 100 may be embodied as various types of electronic apparatuses such as, for example, and without limitation, a cellular phone, a smart phone, a laptop computer, a desktop computer, a tablet personal computer (PC), an e-book terminal, a digital broadcast terminal, a personal digital assistant (PDA), a portable multimedia player (PMP), a navigation device, an MP3 player, a camcorder, an Internet protocol television (IPTV), a digital television (DTV), a wearable device, or the like, but embodiments are not limited thereto.

In an example embodiment, the display apparatus 200 may be a TV but may be embodied as an electronic apparatus having a display. For example, the display apparatus 200 may be embodied in various forms. For example, the display apparatus 200 may be embodied as various types of electronic apparatuses such as, for example, and without limitation, a cellular phone, a tablet PC, a digital camera, a camcorder, a laptop computer, a desktop computer, an e-book terminal, a digital broadcast terminal, a PDA, a PMP, a navigation device, an MP3 player, a wearable device, or the like. In particular, example embodiments are easily applicable to a display apparatus having a large-sized display such as a TV but are not limited thereto. The display apparatus 200 may be a fixed display apparatus or a mobile display apparatus and may be digital broadcast receiver capable of receiving digital broadcasts.

In example embodiments of the present disclosure, the term “user” may represent a human being who controls a function or an operation of an electronic apparatus and should be understood to include a manager or an installation engineer.

In an example embodiment, the electronic apparatus 100 and the display apparatus 200 may communicate with each other. For example, electronic apparatus 100 may transmit data, a signal, or the like, to or receive data, a signal, or the like, from the display apparatus 200 through short-range communication. Examples of the short-range communication may include a Wi-Fi method, a near-field communication (NFC) method, a Bluetooth method, an infrared method, a ZigBee method, or the like, but are not limited thereto.

In an example embodiment, the electronic apparatus 100 and the display apparatus 200 may periodically transmit device identification information to an external device through, for example, BLE communication, or the like, but is not limited thereto. The electronic apparatus 100 may recognize the presence of the display apparatus 200 close to the electronic apparatus 100 based on device identification information received from the display apparatus 200. Similarly, the display apparatus 200 may recognize the electronic apparatus 100 close to the display apparatus 200 based on device identification information received from the electronic apparatus 100. In an example embodiment, when the display apparatus 200 recognizes the presence of the electronic apparatus 100 while the display of the display apparatus 200 is an ‘off’ state or a stand mode state, the display of the display apparatus 200 may be made to be automatically ‘on’.

When the electronic apparatus 100 recognizes the display apparatus 200, the electronic apparatus 100 may perform pairing with the display apparatus 200 based, for example, on a user input. For example, when the electronic apparatus 100 recognizes the display apparatus 200, the electronic apparatus 100 may display a button, an icon or the like to connect the electronic apparatus 100 to the display apparatus 200. When the button, the icon, or the like is selected, the electronic apparatus 100 may perform pairing with the display apparatus 200. When pairing is performed between the electronic apparatus 100 and the display apparatus 200, the electronic apparatus 100 and the display apparatus 200 may transmit data to or receive data from each other.

In an example embodiment, the electronic apparatus 100 may perform web browsing and display a web page provided from a web server. When pairing is performed between the electronic apparatus 100 and the display apparatus 200, the electronic apparatus 100 may transmit web page information for displaying a web page to the display apparatus 200. For example, the web page information may be information for connecting to a web server providing the web page and displaying the web page, and may include of uniform resource locator (URL) information and session information of the web page, but is not limited thereto.

The electronic apparatus 100 may encrypt the session information of the web page and transmit the encrypted session information to the display apparatus 200. In this case, the session information may, for example, be transmitted using a web standard protocol (e.g., a web socket protocol), or the like.

The display apparatus 200 may receive the web page information from the electronic apparatus 100, be connected to the web server providing the web page based on the received web page information, and display the web page. For example, the encrypted session information may be decrypted and the web page may be displayed using the decrypted session information.

In an example embodiment, when the web page displayed on the electronic apparatus 100 is a web page corresponding to a user who logs on, the display apparatus 200 may log on the web page using the session information and display the web page corresponding to the user who logs on. In an example embodiment, the display apparatus 200 may not directly display the web page displayed on the electronic apparatus 100 and may display the web page according to a layout and at a resolution optimized or set for the display apparatus 200. For example, the display apparatus 200 may request the web server providing the web page to provide a web page having a layout and a resolution optimized for the display apparatus 200, and may receive and display the provided web page from the web server.

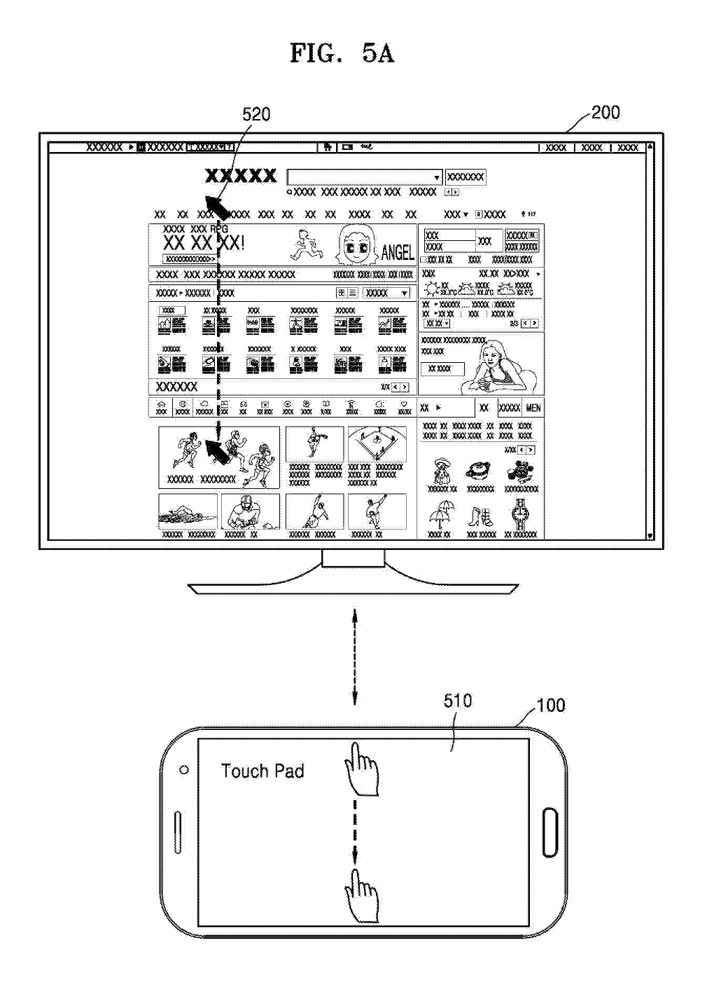

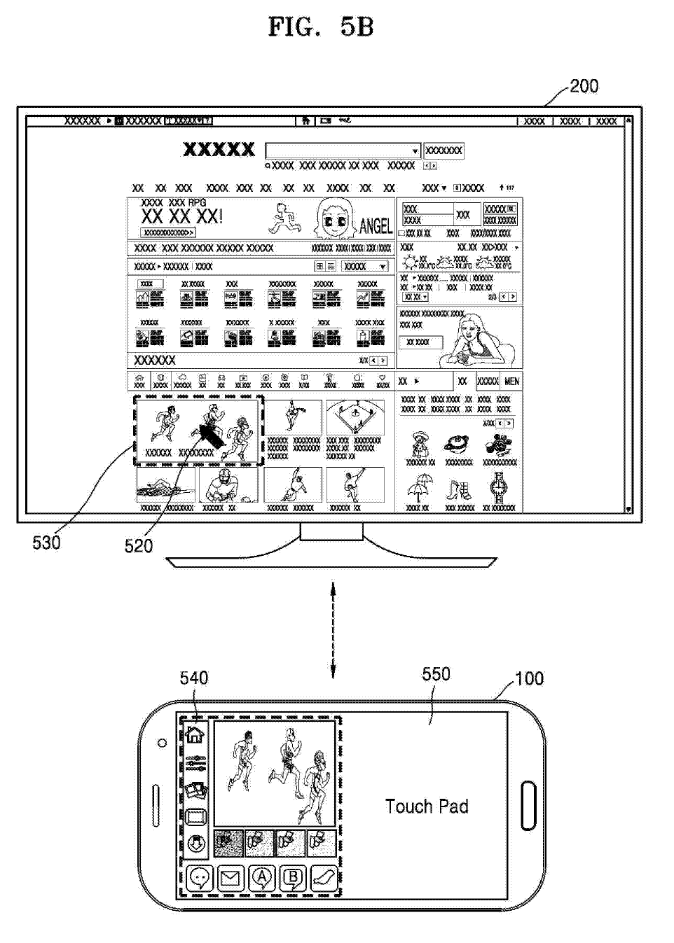

When the web page is displayed on the display apparatus 200, the electronic apparatus 100 may display a control interface 10 for controlling web content contained in the web page. The electronic apparatus 100 may display a different control interface based on web content selected from the web page, as will be described in greater detail below with reference to FIGS. 5A to 10B below.

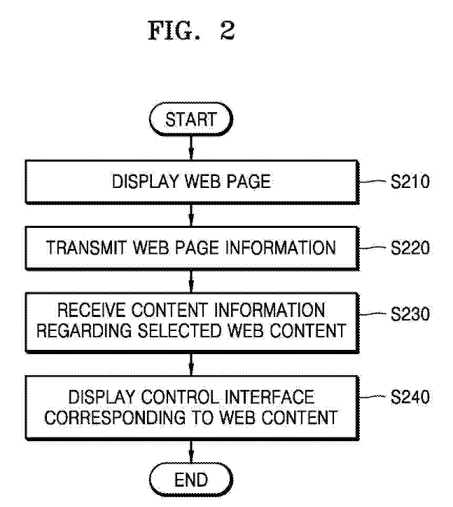

FIG. 2 is a flowchart illustrating an example method of operating an electronic apparatus according to an example embodiment of the present disclosure.

Referring to FIG. 2, the electronic apparatus 100 of FIG. 1 according to an embodiment may display a web page (operation S210).

For example, the electronic apparatus 100 may perform web browsing, and display a web page provided from a web server as web browsing is performed. The web page may contain at least one web content. The web content may be content provided on a web, and may include at least one among image content, text content, audio content, video content, and game content, or the like, but is not limited thereto.

In an example embodiment, the electronic apparatus 100 may perform pairing with a display apparatus close to the electronic apparatus 100. For example, the electronic apparatus 100 may recognize the presence of a display apparatus close to the electronic apparatus 100, request to connect to the recognized display apparatus, and be then connected to the display apparatus.

The electronic apparatus 100 may transmit web page information for displaying the web page to the display apparatus paired with the electronic apparatus 100 (operation S220).

The web page information may include session information of the web page. The electronic apparatus 100 may encrypt the session information of the web page and transmit the encrypted session information to a display apparatus. The display apparatus may display the web page by receiving web page information.

When web content is selected from the web page displayed on the display apparatus, the electronic apparatus 100 may receive content information regarding the selected web content (operation S230).

The display apparatus may analyze the selected web content and transmit content information indicating the type of the web content to the electronic apparatus 100.

In an example embodiment, the electronic apparatus 100 may determine and display a control interface corresponding to the web content based on the received content information (operation S240).

The electronic apparatus 100 may determine the type of the selected web content based on the content information, and control a different control interface to be displayed based on the type of the web content.

For example, when the web content is image content or text content, the electronic apparatus 100 may display the image content or the text content, and display a control interface for performing at least one among selecting the image content or the text content, editing the image content or the text content, storing the image content or the text content, and sharing the image content or the text content. When the web content is video content or audio content, the electronic apparatus 100 may display a control interface for performing at least one among reproducing the video content or the audio content, stopping the reproducing of the video content or the audio content, volume control, reproduction speed control, and reproduction time setting, or the like, but is not limited thereto. When the web content is game content, the electronic apparatus 100 may display a control interface which includes at least one key for manipulating the game content and which is set based on the type of game content or a user input. However, embodiments are not limited thereto.

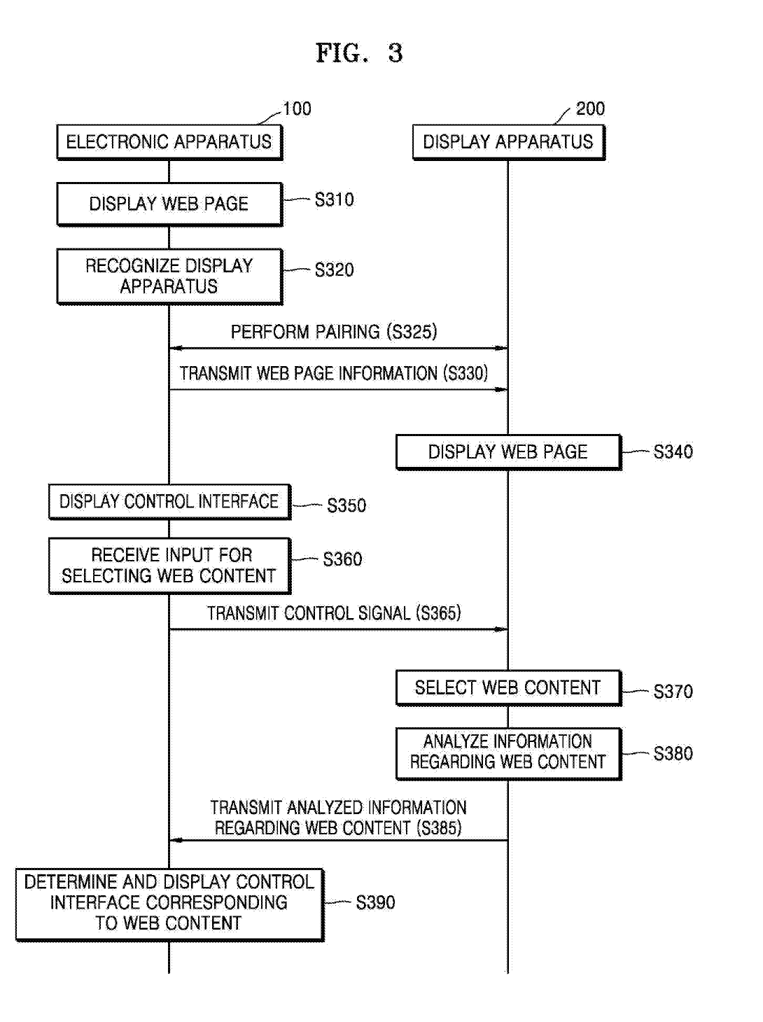

FIG. 3 is a flowchart illustrating an example method of operating an electronic apparatus and a display apparatus according to an example embodiment of the present disclosure.

Referring to FIG. 3, an electronic apparatus 100 according to an embodiment may display a web page (operation S310). Operation S310 of FIG. 3 corresponds to operation S210 of FIG. 2 and is thus not described again here.

The electronic apparatus 100 may recognize a display apparatus 200 close to the electronic apparatus 100 (operation S320) and may perform pairing with the display apparatus 200 (operation S325).

For example, the display apparatus 200 may periodically transmit identification information to an external device through BLE communication, or the like, but is not limited thereto. When the display apparatus 200 is located within a predetermined distance from the electronic apparatus 100, the electronic apparatus 100 may receive the identification information from the display apparatus 200 and may thus recognize the presence of the display apparatus 200.

The electronic apparatus 100 may transmit a connection request message to the display apparatus 200, and perform pairing between the electronic apparatus 100 and the display apparatus 200 by receiving a connection request response message from the display apparatus 200. In this case, the connection request message may include device identification information of the electronic apparatus 100 or user authentication information of the electronic apparatus 100.

The device identification information is unique information identifying the electronic apparatus 100 to be distinguished from other electronic apparatuses, and may include, for example, the model name, serial number, etc. of the electronic apparatus 100. The user authentication information may include user identification (ID), user password, user account, or the like, of a user of the electronic apparatus 100 but is not limited thereto. However, embodiments are not limited thereto.

The display apparatus 200 may generate the connection request response message which is a response to the connection request message, and transmit the connection request response message to the electronic apparatus 100. The connection request response message may include a connection acceptance message or a connection rejection message. When the connection request response message includes the connection acceptance message, the electronic apparatus 100 and the display apparatus 200 may be connected to each other to transmit data to or receive data from each other.

When device identification information or user authentication information contained in the connection request message is identification information or user authentication information regarding a device which has previously been connected, the electronic apparatus 100 and the display apparatus 200 may be connected without conducting an additional authentication process (e.g., a PIN number, QR code, or the like).

Furthermore, the electronic apparatus 100 may transmit web page information for displaying a web page to the display apparatus 200 paired thereto (operation S330). Operation 330 of FIG. 3 corresponds to operation S220 of FIG. 2 and will not be redundantly described again here.

The display apparatus 200 may display the web page based on the received web page information (operation S340).

For example, when the web page displayed on the electronic apparatus 100 is a web page corresponding to a user who logs on, the display apparatus 200 may log on the web page using session information and display the web page corresponding to the user who logs on. The display apparatus 200 may not not directly display a web page screen displayed on the electronic apparatus 100 and may display a web page screen changed based on a layout and a resolution optimized for the display apparatus 200.

The electronic apparatus 100 may display a control interface for controlling the web page when the web page is displayed on the display apparatus 200 (operation S350). For example, the electronic apparatus 100 may display a touch control interface. The electronic apparatus 100 may receive an input for moving a pointer displayed on the display apparatus 200 and an input for selecting web content included in the web page through the control interface (operation S360), and transmit a control signal corresponding to the received inputs to the display apparatus 200 (operation S365).

The display apparatus 200 may move the pointer on the web page or select web content included in the web page based on the received control signal (operation S370).

When web content is selected, the display apparatus 200 may analyze information regarding the selected web content. For example, the type of the web content may be analyzed based on a tag attribute of the web content on which the pointer is located (operation S380).

The display apparatus 200 may transmit the analyzed information regarding the web content to the electronic apparatus 100 (operation S385). For example, the information regarding the web content may include information indicating the type of the selected web content, and may be transmitted to the electronic apparatus 100 by using an encrypted transmission protocol.

The electronic apparatus 100 may determine and display a control interface corresponding to the web content based on the received information regarding the web content (operation S390). Operation S390 of FIG. 3 corresponds to operation S240 of FIG. 2 and is not described again here.

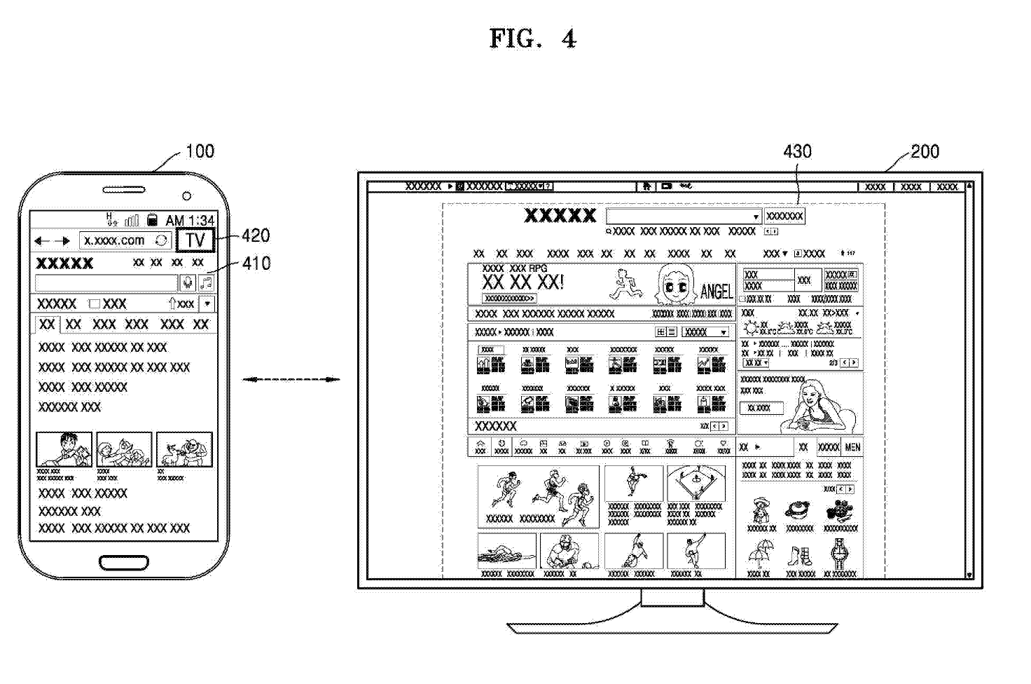

FIG. 4 is a diagram illustrating an example method of displaying a web page displayed on an electronic apparatus on a display apparatus according to an example embodiment of the present disclosure.

Referring to FIG. 4, an electronic apparatus 100 according to an embodiment may display a web page 410. For example, the electronic apparatus 100 may perform web browsing to display the web page 410 provided from a web server. In this case, the web page 410 may be a web page which is logged on using user information.

The electronic apparatus 100 may perform pairing with the display apparatus 200 located in proximity to the electronic apparatus 100. For example, the display apparatus 200 may periodically transmit device identification information to an external device through BLE communication, or the like, but is not limited thereto. When the display apparatus 200 is located within a predetermined distance from the electronic apparatus 100, the electronic apparatus 100 may receive the device identification information of the display apparatus 200 and recognize the presence of the display apparatus 200 but embodiments are not limited thereto.

The electronic apparatus 100 may display a first icon 420 when the presence of the display apparatus 200 is recognized. When receiving an input for selecting the first icon 420, the electronic apparatus 100 may perform pairing with the display apparatus 200.

When pairing is performed, the electronic apparatus 100 may transmit web page information for displaying a web page to the display apparatus 200. In this case, the web page information may be session information of the web page. The electronic apparatus 100 may encrypt the session information of the web page and transmit the encrypted session information to the display apparatus 200 using a web standard protocol (e.g., a web socket protocol). However, embodiments are not limited thereto.

The display apparatus 200 may decrypt the received encrypted session information and display a web page 430 based on the decrypted session information. Accordingly, the display apparatus 200 may display a web page displayed on the electronic apparatus 100. For example, when the electronic apparatus 100 displays a web page which the electronic apparatus 100 logs on, the display apparatus 200 may also display the web page which the display apparatus 100 logs on.

Furthermore, the display apparatus 200 may display a web page changed based on specifications thereof. For example, the display apparatus 200 may display a web page optimized for a layout and a resolution provided by the display apparatus 200. Thus, as illustrated in FIG. 4, when the electronic apparatus 100 displays a mobile version of the web page 410, the display apparatus 200 may display a PC version of the web page 430.

FIGS. 5A and 5B are diagrams illustrating an example method of displaying a control interface when image content is selected, the method performed by an electronic apparatus, according to an example embodiment of the present disclosure.

Referring to FIG. 5A, when a web page is displayed on a display apparatus 200, an electronic apparatus 100 may display a touch input interface 510. The electronic apparatus 100 may receive a user input for performing, for example, and without limitation, dragging, touching, or flipping through the touch input interface 510. The electronic apparatus 100 may control the display apparatus 200 based on the received user input. For example, as illustrated in FIG. 5A, when the electronic apparatus 100 receives a user input for performing dragging downward and transmits a control signal corresponding to this user input to the display apparatus 200, the display apparatus 200 may move a pointer 520 displayed on a display thereof downward.

When the pointer 520 displayed on the display apparatus 200 is located on web content included in the web page or when the web content is selected, the display apparatus 200 may transmit content information regarding the web content to the electronic apparatus 100.

In an example embodiment, the web content is content provided at a web and may refer, for example, to processed content distributed via the Internet. The web content may include at least one among image content, text content, audio content, video content and game content but is not limited thereto.

The electronic apparatus 100 may receive content information and provide a control interface based on the type of web content selected by the display apparatus 200 based on the content information.

For example, as illustrated in FIG. 5B, when the pointer 520 is located on image content 530 included in a web or when the image content 530 is selected, the electronic apparatus 100 may display the image content 530, and the image control interface 540 for performing at least one among, for example, and without limitation, selecting the image content 530, editing the image content 530, storing the image content 530, and sharing the image content 530, or the like. For example, the image control interface 540 may include icons corresponding to an editing function, icons corresponding to a storing function, and icons corresponding to a sharing function. Thus, the electronic apparatus 100 may control colors, a size, or the like, of the image content 530 using the editing function, store the image content 530 in the electronic apparatus 100 using the storing function, and share the image content 530 with a user of another device using the sharing function. However, embodiments are not limited thereto and various functions may be performed using the image control interface 540.

Furthermore, the electronic apparatus 100 may display a touch input interface 550 having a touch input region, together with the image control interface 540. Thus, while the image content 530 is controlled or after controlling of the image content 530 is completed, another menu or the like displayed on the display apparatus 200 may be selected by moving the pointer 520 displayed on the display apparatus 200 to a different location through a touch input or the like.

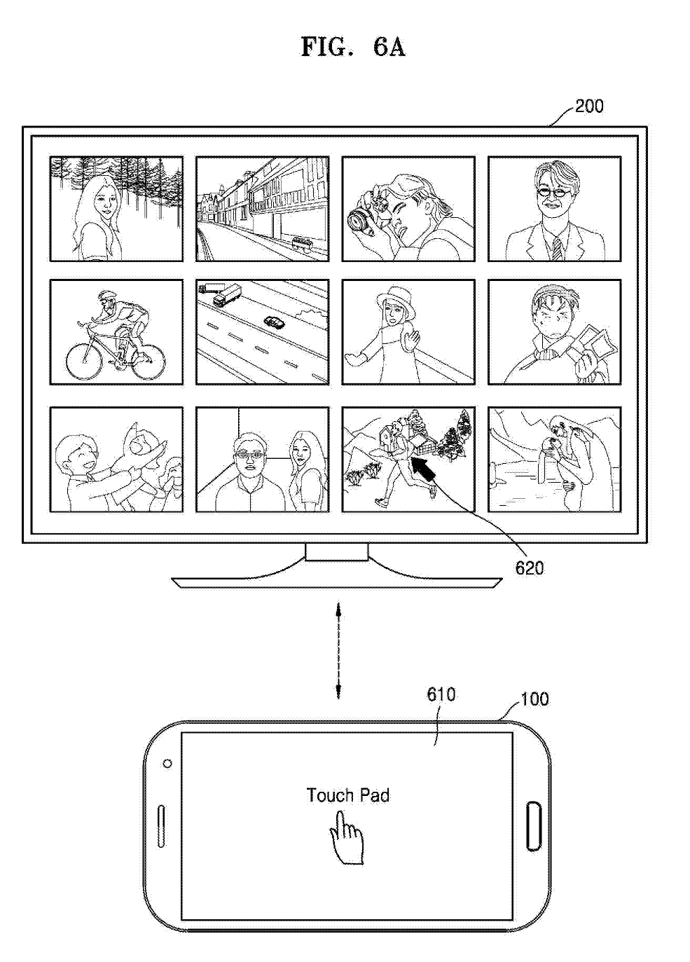

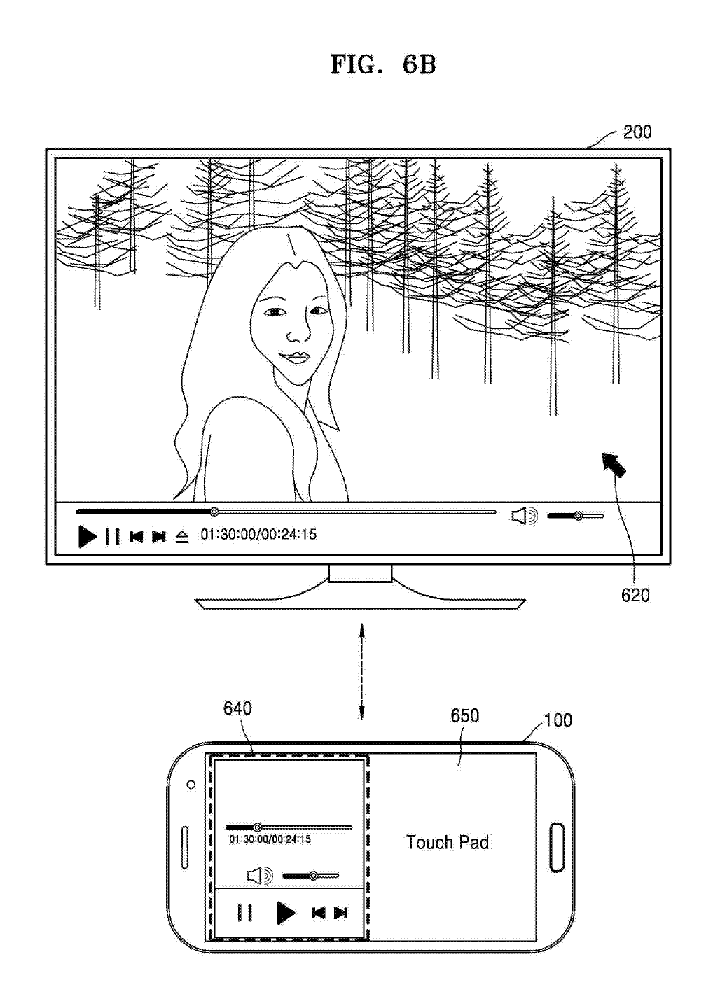

FIGS. 6A and 6B are diagrams illustrating an example method of displaying a control interface when video content is selected, the method performed by an electronic apparatus, according to an example embodiment of the present disclosure.

Referring to FIG. 6A, a display apparatus 200 may display a web content list. For example, the web content list may be a list including a plurality of video content items. An electronic apparatus 100 may receive a user input for performing, for example, and without limitation, dragging, touching, or flipping, or the like, through a touch input interface 610 displayed thereon. The display apparatus 200 may select one of the plurality of video content items included in the list by moving a pointer 620 based on the user input received by the electronic apparatus 100.

When video content is selected, the display apparatus 200 may transmit content information regarding the video content to the electronic apparatus 100, and reproduce the selected video content. For example, as illustrated in FIG. 6B, a display apparatus 200 may display a video reproduced from the selected video content.

The electronic apparatus 100 may provide a control interface based on the type of the selected web content based on content information received from the display apparatus 200. For example, as illustrated in FIG. 6B, the electronic apparatus 100 may display a video control interface 640 for controlling the video content reproduced in the display apparatus 200. The video control interface 640 may include, but is not limited to, an object for reproducing the video content, an object for stopping reproduction of the video content, an object for controlling volume of the video content, an object for controlling a reproduction speed of the video content, a time control bar for setting a reproduction time of the video content, or the like.

Thus, when receiving an input for selecting one of the objects included in the video control interface 640, the electronic apparatus 100 may transmit a control signal corresponding to the input to the display apparatus 200 and the display apparatus 200 may control reproduction of the video content according to the control signal received from the electronic apparatus 100.

Furthermore, the electronic apparatus 100 may also display a touch input interface 650 having a touch input region. Thus, another menu or the like displayed on the display apparatus 200 may be selected by moving a pointer 620 displayed on the display apparatus 200 to a different location according to a user input which is input using the touch input interface 650.

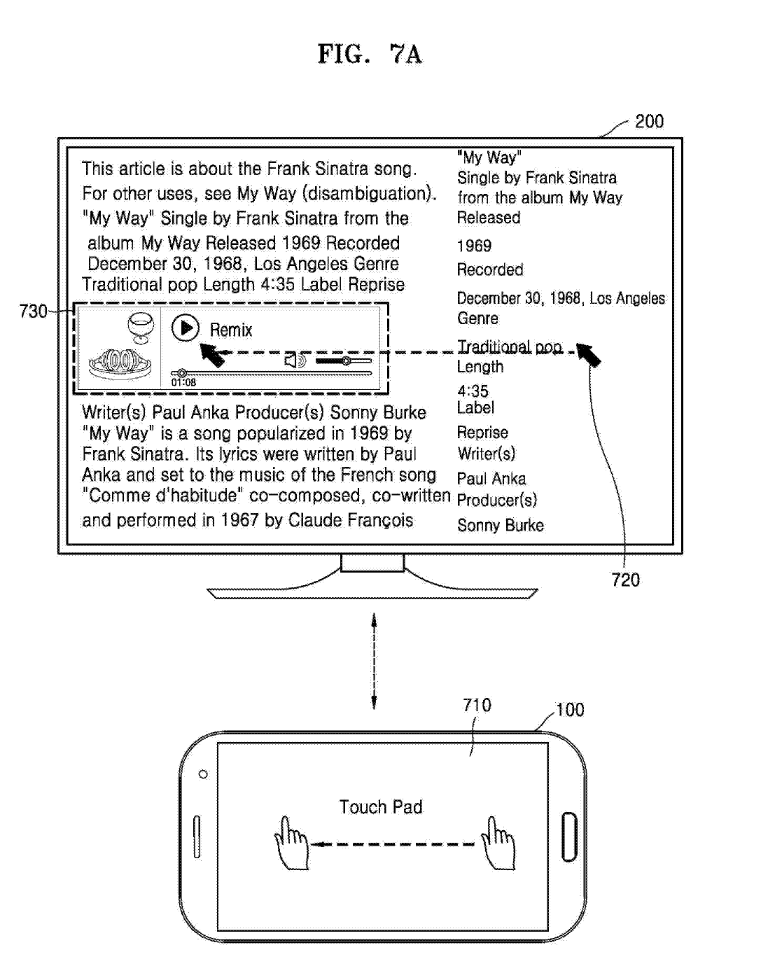

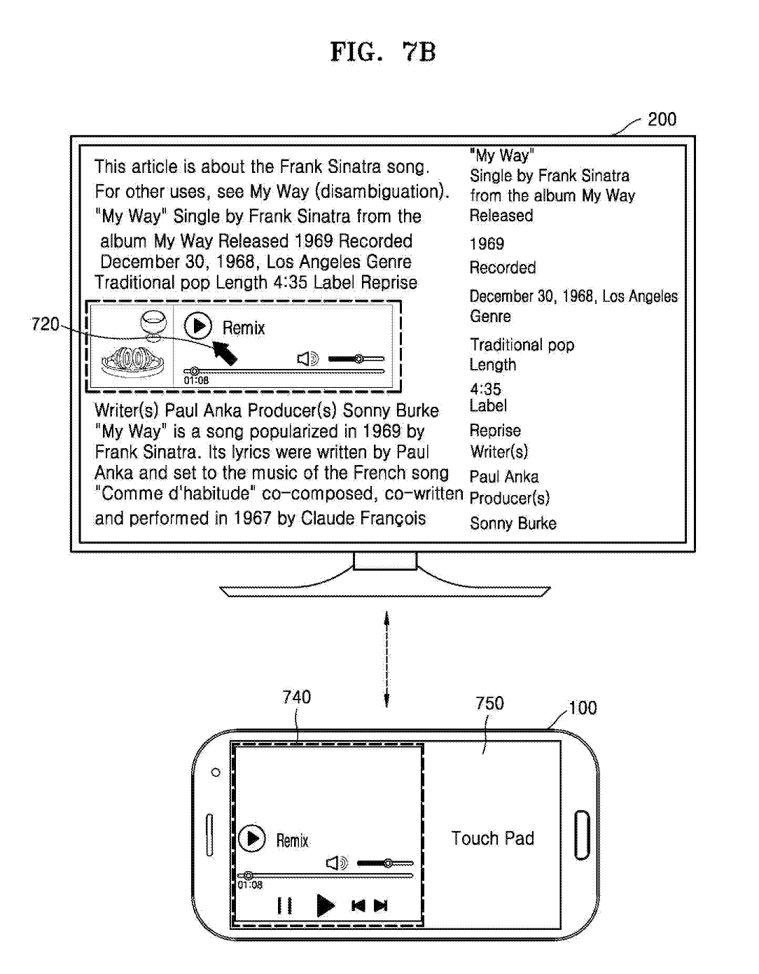

FIGS. 7A and 7B are diagrams illustrating an example method of displaying a control interface when audio content is selected, the method performed by an electronic apparatus, according to an example embodiment of the present disclosure.

Referring to FIG. 7A, a display apparatus 200 may display a web page including audio content. An electronic apparatus 100 may receive a user input for performing, for example, and without limitation, dragging, touching, or flipping, or the like, through a touch input interface 710 displayed thereon. The display apparatus 200 may select audio content 730 by locating a pointer 720 on a region in which the audio content 730 is displayed or selecting a button for reproducing the audio content 730 by moving the pointer 720 based on a user input received by the electronic apparatus 100.

When audio content is selected, the display apparatus 200 may transmit content information regarding the audio content to the electronic apparatus 100, and reproduce the selected audio content.

The electronic apparatus 100 may provide a control interface based on the type of selected web content on the basis of content information received from the display apparatus 200. For example, as illustrated in FIG. 7B, an audio control interface 740 for controlling audio content reproduced in the display apparatus 200 may be displayed. The audio control interface 740 may include, but is not limited to, an object for reproducing the audio content, an object for stopping reproduction of the audio content, an object for controlling volume of the audio content, an object for controlling a reproduction speed of the audio content, a time control bar for setting a reproduction time of the audio content, or the like.

Thus, when receiving an input for selecting one of the objects included in the audio control interface 740, the electronic apparatus 100 may transmit a control signal corresponding to the input or the like to the display apparatus 200, and the display apparatus 200 may control reproduction of the audio content based on the control signal received from the electronic apparatus 100.

The electronic apparatus 100 may also display a touch input interface 750 having a touch input region. Thus, another menu or the like displayed on the display apparatus 200 may be selected by moving a pointer displayed on the display apparatus 200 to a different location based on a user input which is input using the touch input interface 750.

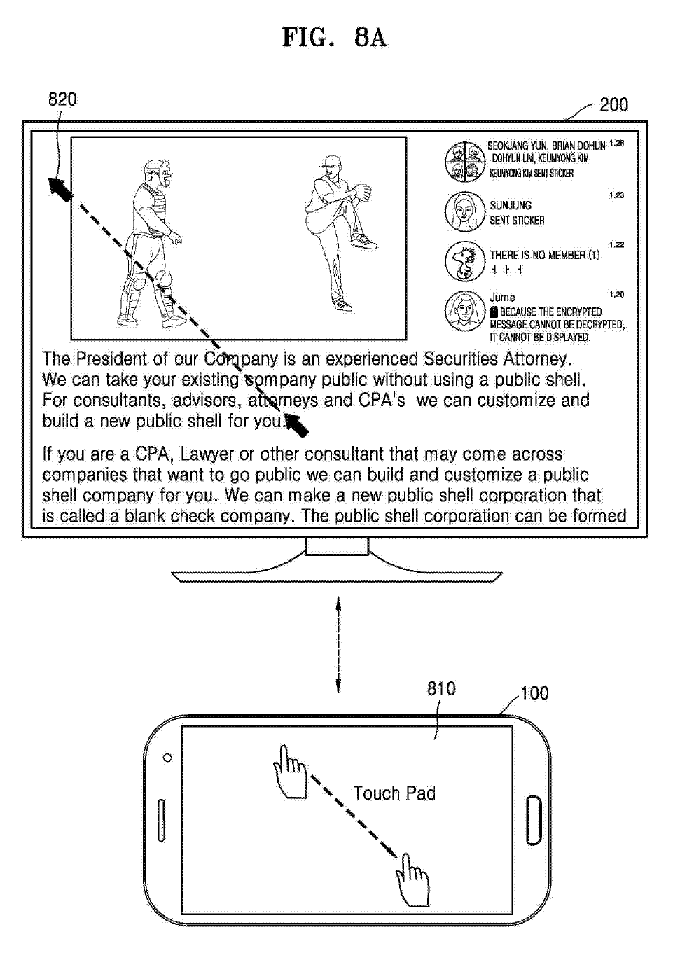

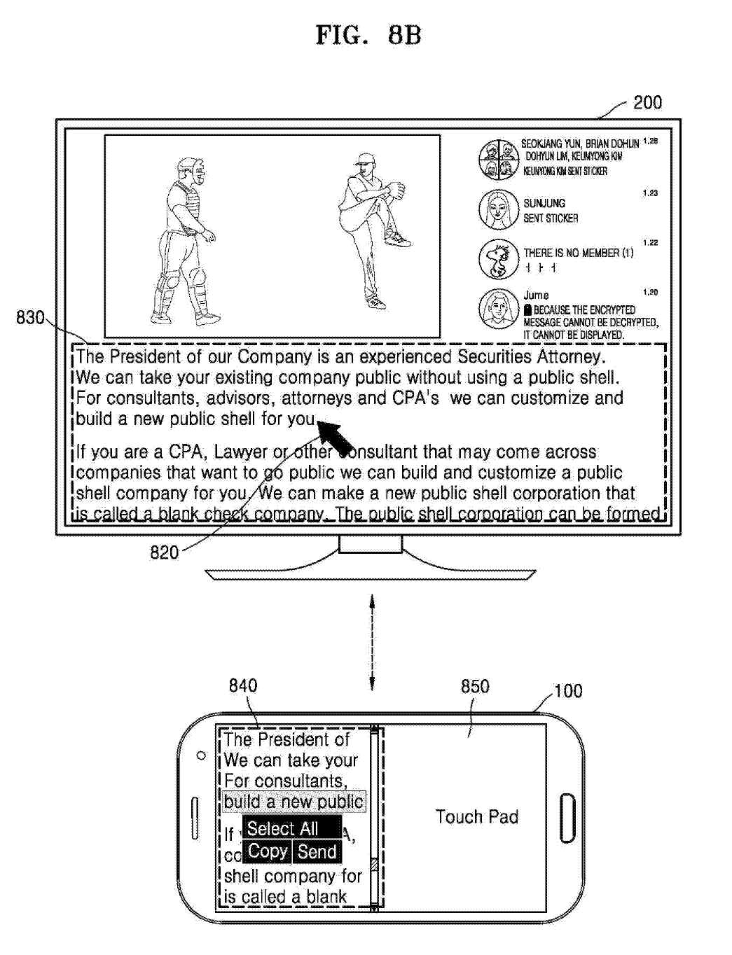

FIGS. 8A and 8B are diagrams illustrating an example method of displaying a control interface when text content is selected, the method performed by an electronic apparatus, according to an example embodiment of the present disclosure.

Referring to FIG. 8A, a display apparatus 200 may display a web page including text content. An electronic apparatus 100 may receive a user input for performing, for example, and without limitation, dragging, touching, or flipping, or the like, through a touch input interface 810 displayed thereon. The display apparatus 200 may select text content 830 by moving a pointer 820 to a region in which the text content 830 is displayed according to a user input received by the electronic apparatus 100.

When the text content 830 is selected, the display apparatus 200 may transmit the text content 830 and content information regarding the text content 830 to the electronic apparatus 100.

The electronic apparatus 100 may provide a control interface based on the content information received from the display apparatus 200. For example, as illustrated in FIG. 8B, a text control interface 840 for controlling the text content 830 may be displayed. The text control interface 840 may display text included in the text content 830, and may also display a scroll bar when the text cannot be completely displayed. Furthermore, the text control interface 840 may provide a function of selecting at least a part of the displayed text, a function of copying selected text, a function of transmitting the selected text, a function of sharing the selected text, a function of storing the selected text, or the like.

The electronic apparatus 100 may also display a touch input interface 850 having a touch input region. Thus, while the text content is controlled or after controlling of the text content is completed, another menu or the like displayed on the display apparatus 200 may be selected by moving the pointer 820 displayed on the display apparatus 200 to a different location through a touch input or the like.

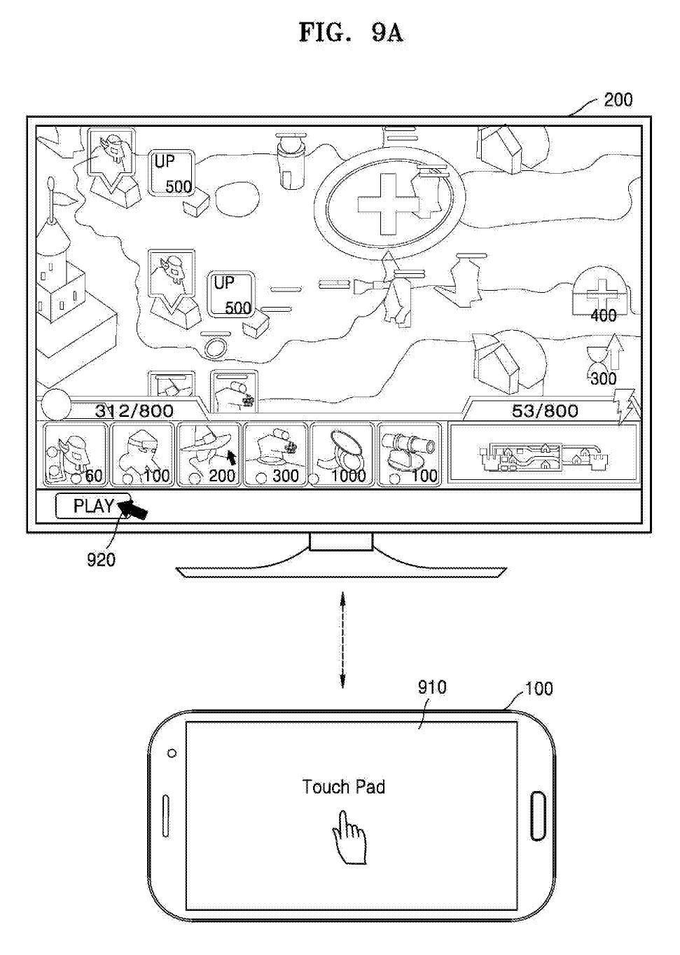

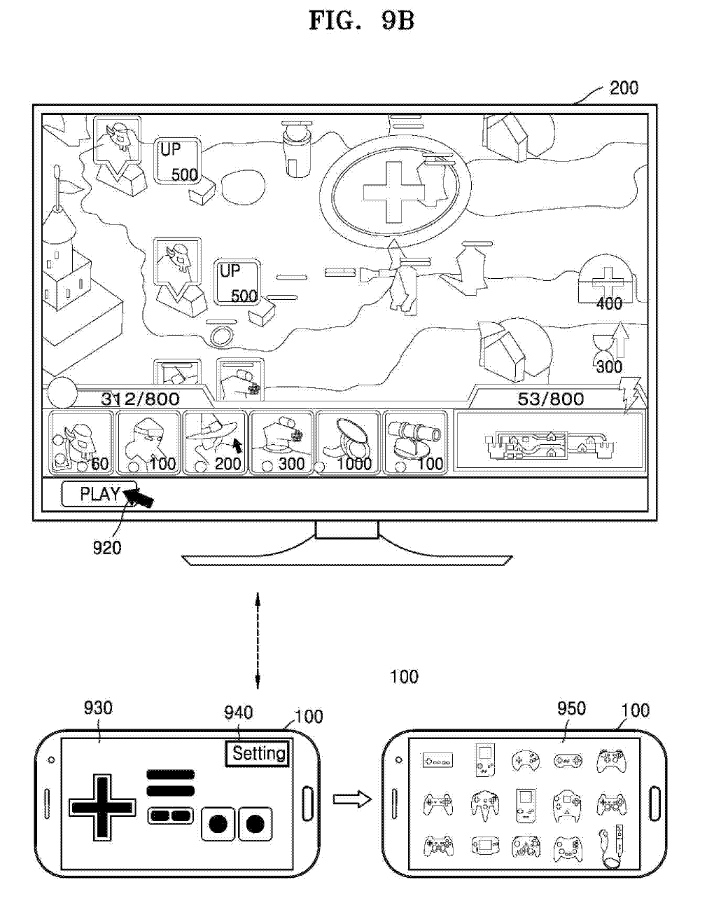

FIGS. 9A and 9B are diagrams illustrating an example method of displaying a control interface when game content is selected, the method performed by an electronic apparatus, according to an example embodiment of the present disclosure.

Referring to FIG. 9A, a display apparatus 200 may display a web page including game content. The electronic apparatus 100 may receive a user input for performing, for example, and without limitation, dragging, touching or flipping, or the like, through a touch input interface 910 displayed thereon. The display apparatus 200 may execute the game content by moving a pointer 920 based on the user input received by the electronic apparatus 100.

When the game content is executed, the display apparatus 200 may transmit content information regarding the game content to the electronic apparatus 100. The electronic apparatus 100 may provide a control interface according to the type of the game content based on the content information received from the display apparatus 200. For example, as illustrated in FIG. 9B, the electronic apparatus 100 may display a game control interface 930 for controlling the game content executed in the display apparatus 200. The game control interface 930 may include various types of keys for manipulation of a game.

In this case, the type of the game control interface 930 and the number, types and arrangement of the keys included in the game control interface 930 may be predetermined based on selected game content or may be set by a user. For example, when an input for selecting a setting menu 940 included in the game control interface 930 is received, the electronic apparatus 100 may display a plurality of game control interfaces 950. The plurality of game control interfaces 950 may be interfaces provided by a game content developer (or provider). When an input for selecting one of the plurality of game control interfaces 950 is received, the electronic apparatus 100 may provide the selected game control interface 950 to the game control interface 930.

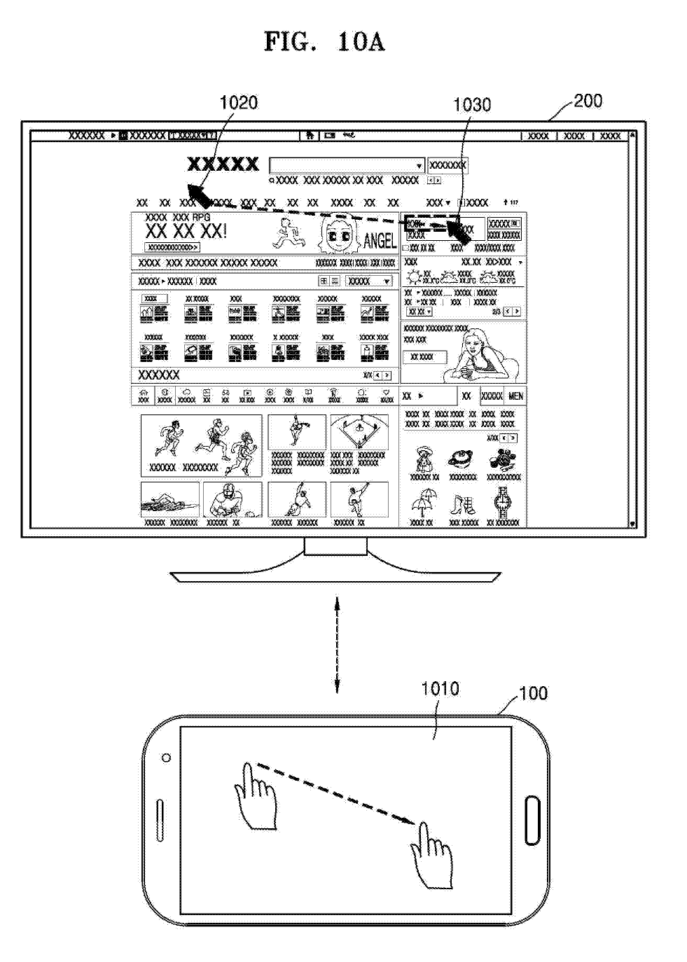

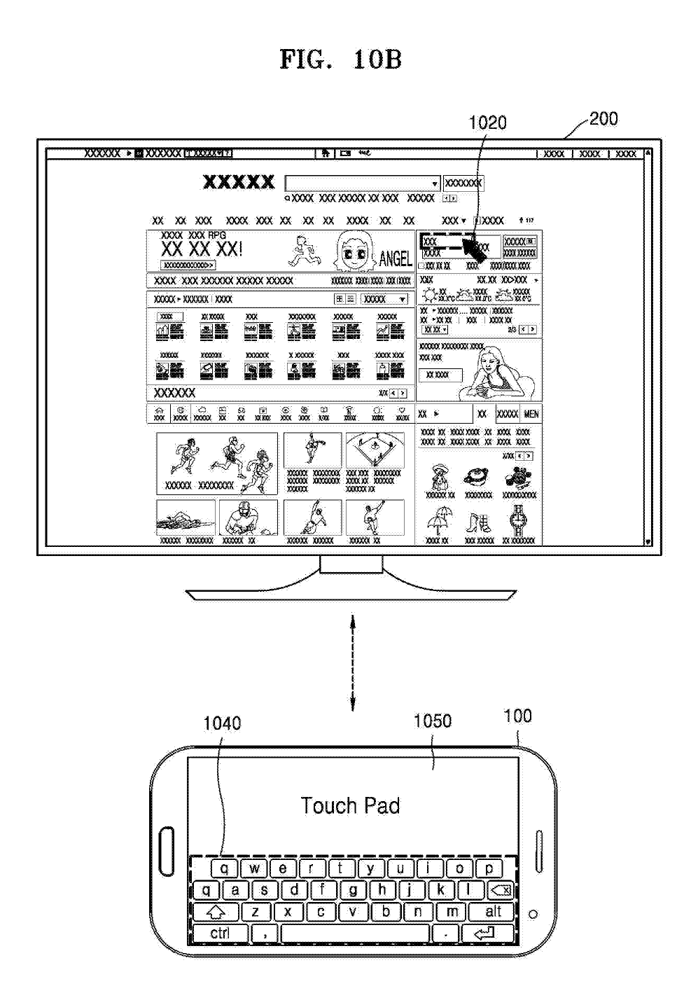

FIGS. 10A and 10B are diagrams illustrating an example method of displaying a control interface when a character input window is selected, the method performed by an electronic apparatus, according to an example embodiment of the present disclosure.

Referring to FIG. 10A, a display apparatus 200 may display a web page including a character input window. An electronic apparatus 100 may receive a user input for performing, for example, and without limitation, dragging, touching or flipping, or the like, through a touch input interface 1010 displayed thereon. The display apparatus 200 may select a character input window 1030 by moving a pointer 1020 based on the user input received by the electronic apparatus 100.

When the character input window 1030 is selected, the display apparatus 200 may transmit content information regarding the character input window 1030 to the electronic apparatus 100, and display a cursor on the character input window 1030.

The electronic apparatus 100 may provide a control interface corresponding to the character input window 1030 based on the content information received from the display apparatus 200. For example, as illustrated in FIG. 10B, a character input interface 1040 for inputting characters on the character input window 1030 displayed on the display apparatus 200 may be displayed. The character input interface 1040 may include a qwerty keyboard, a Chonjiin keyboard, a numeric keyboard, or the like, but is not limited thereto. Accordingly, a user may input characters on an input window displayed on the display apparatus 200 using the character input interface 1040 displayed on electronic apparatus 100.

The electronic apparatus 100 may also display a touch input interface 1050 having a touch input region. Thus, another menu or the like displayed on the display apparatus 200 may be selected by moving a pointer displayed on the display apparatus 200 to a different location according to a user input which is input through the touch input interface 1050.

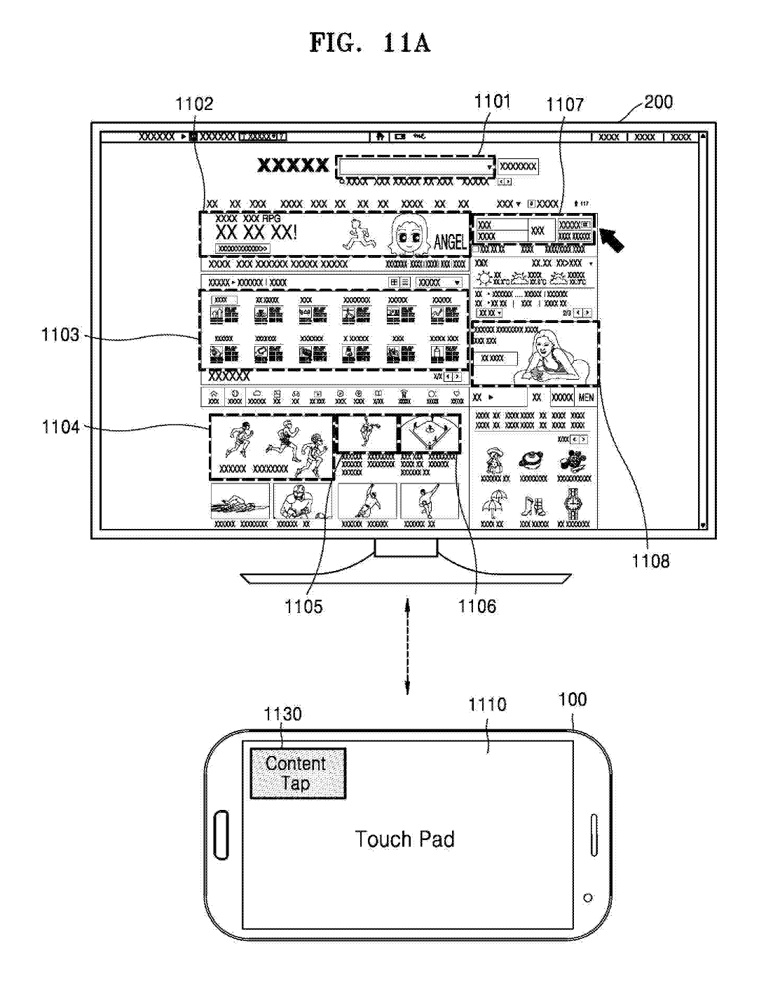

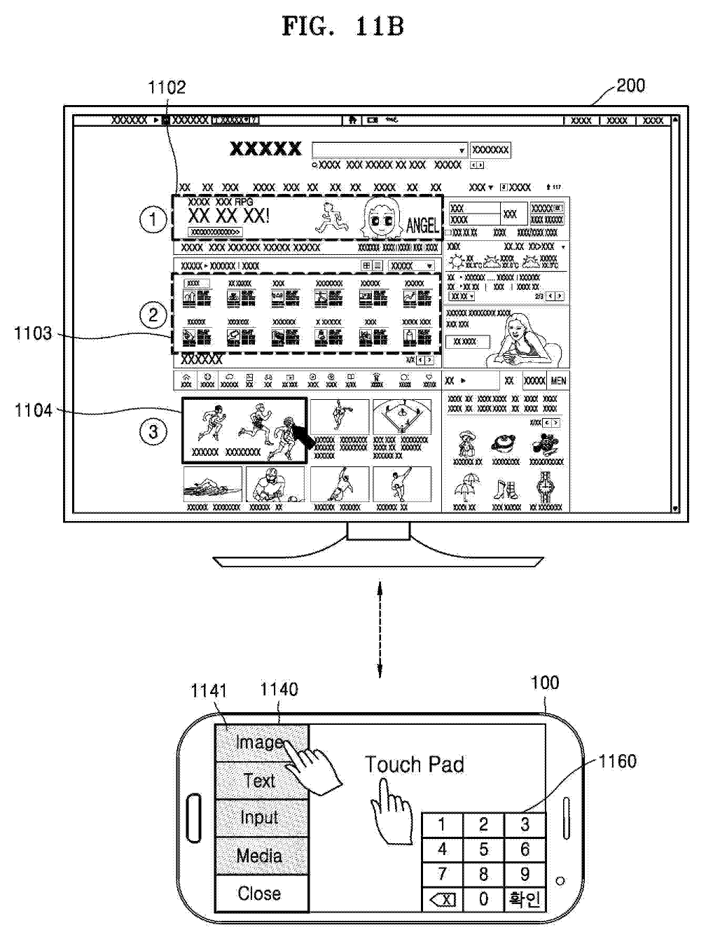

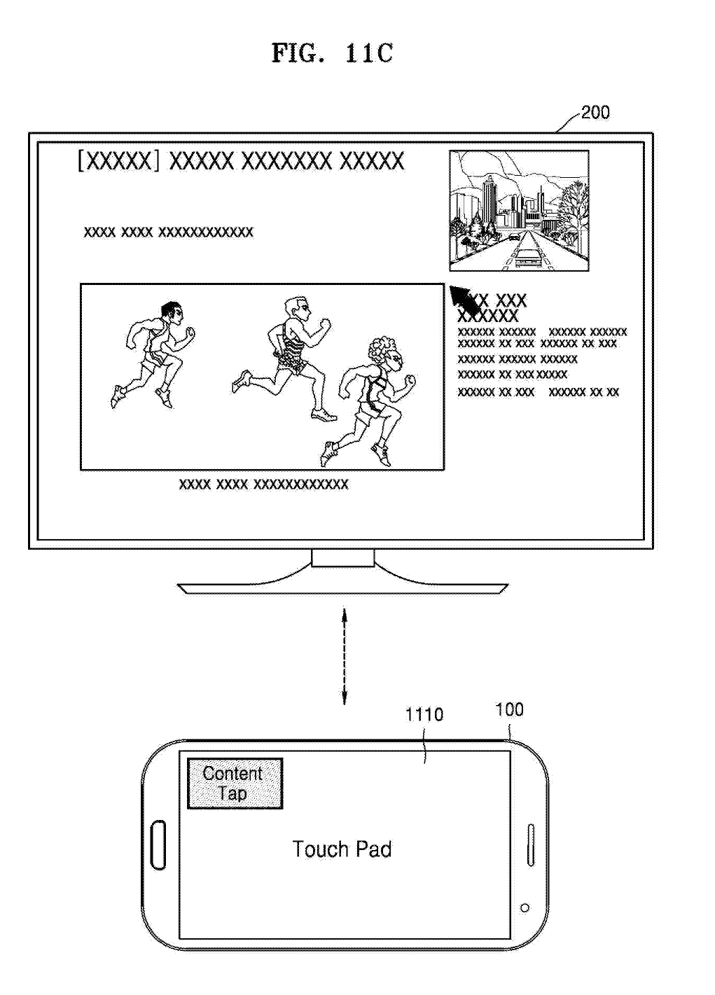

FIGS. 11A, 11B and 11C are diagrams illustrating an example method of selecting web content based on a tab input, the method performed by an electronic apparatus, according to an example embodiment of the present disclosure.

Referring to FIG. 11A, a display apparatus 200 may display a web page. The web page may include a plurality of types of web content. The web page may include a plurality of regions which are set with respect to a web content region, and the plurality of regions may be classified into an image content region, a text content region, a video content region, an audio content region, an input window region, etc. For example, regions 1102, 1103, and 1104 may be image content regions, regions 1101 and 1107 may be input window regions, and regions 1105, 1106, and 1108 may be video content regions.

When the display apparatus 200 displays the web page, the electronic apparatus 100 may display a touch input interface 1110 and the touch input interface 1110 may include a tab icon 1130. When an input for selecting the tab icon 1130 is received, the electronic apparatus 100 may display menu icons 1140 for selecting content type as illustrated in FIG. 11B.

When the electronic apparatus 100 selects an image icon 1141, the display apparatus 200 may move a focus only between the image content regions 1102, 1103, and 1104 included in a web page. For example, when the image icon 1141 is selected and a touch input is received three times through the touch input interface 1110 displayed on the electronic apparatus 100, the display apparatus 200 may move a focus to a third image content region set from among image content regions.

Alternatively, when the electronic apparatus 100 selects the image icon 1141, the display apparatus 200 may display a guide line at a border of each of the image content regions 1102, 1103, and 1104 included in the web page and display a numbers on each of the image content regions 1102, 1103, and 1104. For example, ‘1’ may be displayed on the first image content region 1102, ‘2’ may be displayed on the second image content region 1103, and ‘3’ may be displayed on the third image content region 1104. Furthermore, the electronic apparatus 100 may display number keys 1160 on the touch input interface 1110. When a user input for selecting one of the displayed number keys 1160 is received, the display apparatus 200 may move a focus to an image content region corresponding to the selected number key.

After the focus is moved to the image content region, the electronic apparatus 100 may select image content in the image content region on which the focus is located when a touch input is received. When the image content is selected, the display apparatus 200 may display a page linked to the image content region as illustrated in FIG. 11C.

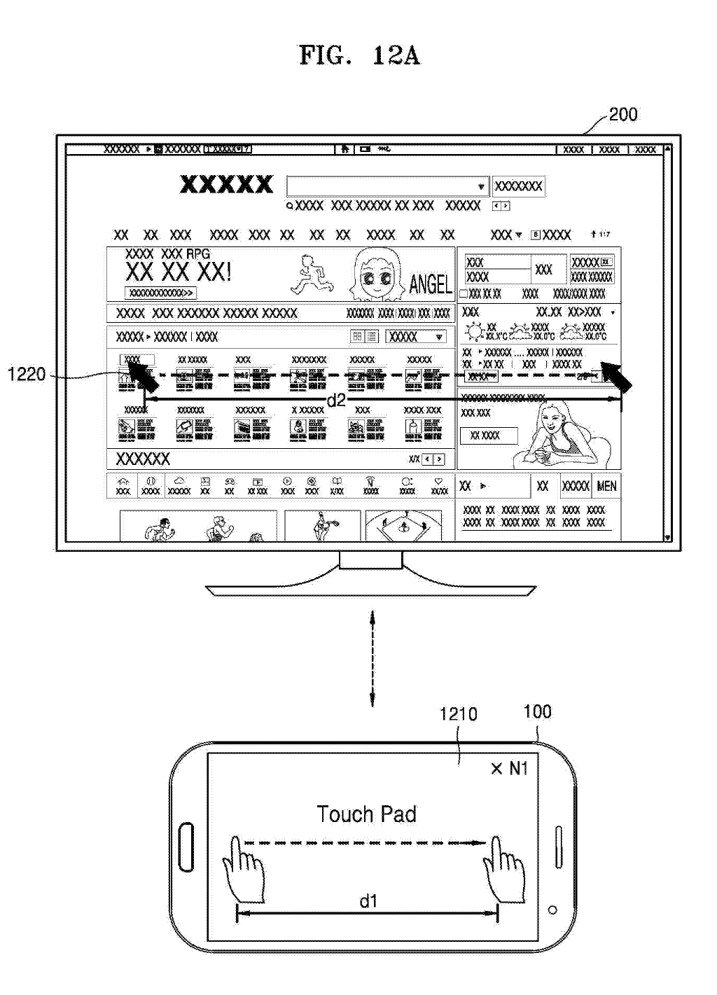

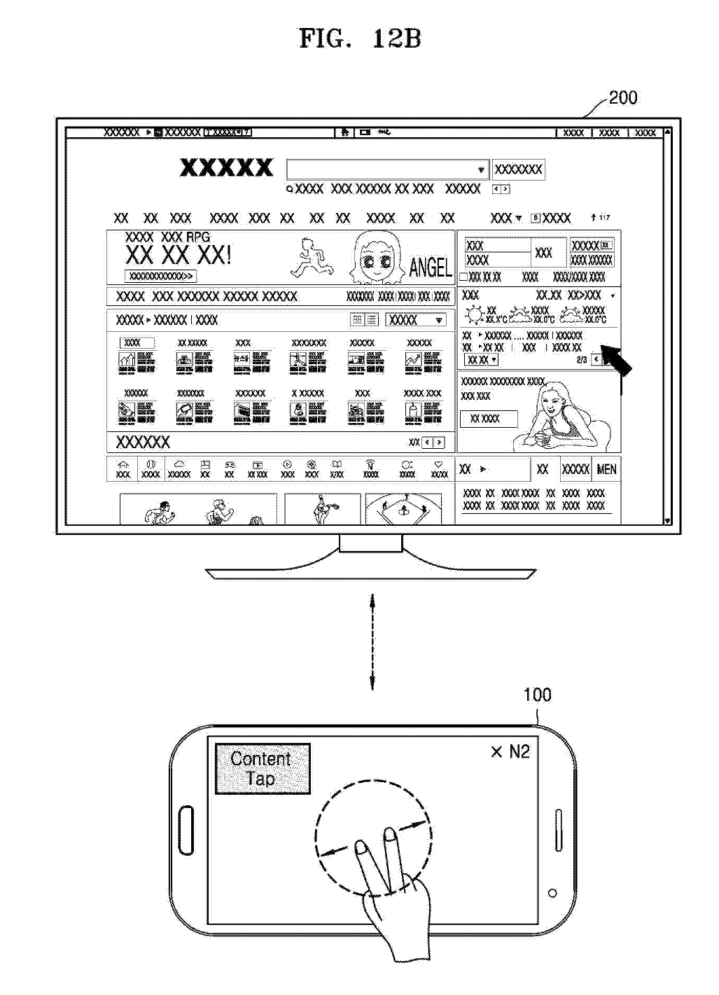

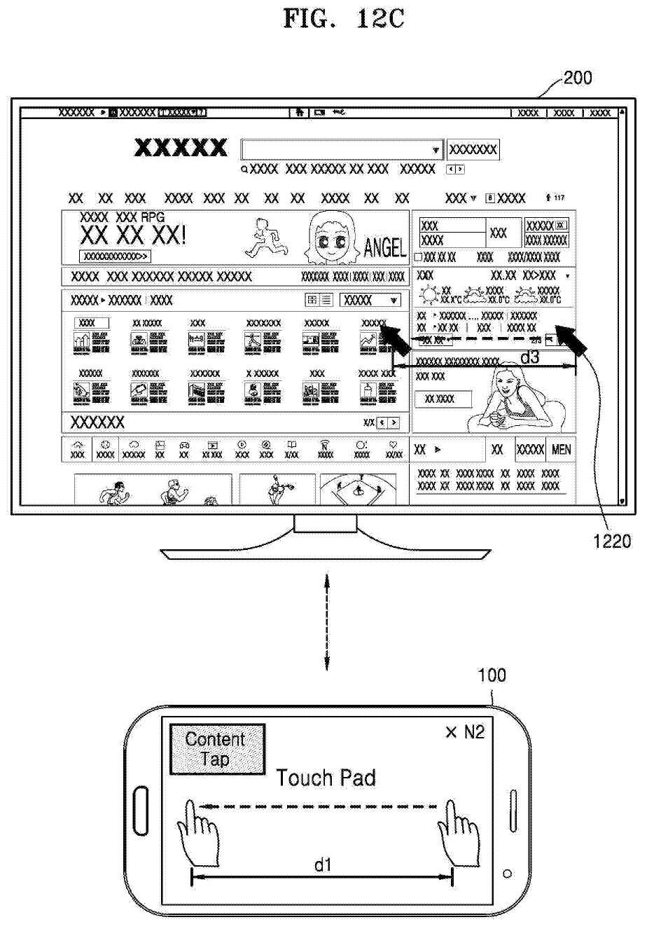

FIGS. 12A, 12B and 12C are diagrams illustrating an example method of controlling a speed of moving a pointer displayed on a display apparatus 200 according to an example embodiment of the present disclosure.

Referring to FIG. 12A, when a display apparatus 200 displays a web page, an electronic apparatus 100 may display a touch input interface 1210. The electronic apparatus 100 may receive a user input for performing, for example, and without limitation, dragging, touching or flipping, or the like, through the touch input interface 1210. The electronic apparatus 100 may control the display apparatus 200 based on the received user input. For example, as illustrated FIG. 12A, when the electronic apparatus 100 receives a user input for performing dragging by a first distance d1 in a first direction, the display apparatus 200 may move a pointer 1220 displayed thereon by a second distance d2 corresponding to the first distance d1 in the first direction. In this case, a ratio of the second distance d2 to the first distance d1 may be a first ratio N1, and a speed of moving the pointer 1220 may be determined based on the first ratio N1. For example, as the ratio of the second distance d2 to the first distance d1 increases, a moving distance of the pointer 1220 on the display apparatus 200 is greater than a distance of a drag input received by the electronic apparatus 100.

Referring to FIG. 12B, the electronic apparatus 100 may receive a pinch input through the touch input interface 1210. The pinch input indicates a user's moving his or her two fingers in different directions while touching a screen with the two fingers. The pinch input may include a pinch zoom-in input indicating a user' moving his or her two fingers in directions to be adjacent to each other while touching a touch input interface 1210 with the two fingers, and a pinch zoon-out input indicating the user's moving his or her two fingers indirections to be distant from each other while touching the touch input interface 1210 with the two fingers.

When receiving the pinch input, the electronic apparatus 100 may control the speed of movement of the pointer 1220 on the display apparatus 200 (or may control sensitivity with respect to a drag input). For example, a ratio between a moving distance of a drag input on the touch input interface 1210 and a moving distance of a cursor on the display apparatus 200 may be determined according to the type of the pinch input and a moving distance according to the pinch input.

As illustrated in FIG. 12B, when the electronic apparatus 100 receives the pinch zoom-out input, the display apparatus 200 may decrease the first ratio N1 to a second ratio N2. In this case, a degree to which the first ratio N1 is to be decreased may be determined according to a moving distance according to the pinch zoom-out input. Thus, as illustrated in FIG. 12C, when the electronic apparatus 100 receives a drag input for performing dragging by the first distance d1 in a second direction, the display apparatus 200 may move the pointer 1220 displayed thereon by a third distance d3 corresponding to the first distance d1 in the second direction. In this case, a ratio of the third distance d3 to the first distance d1 may be the second ratio N2, and the second ratio N2 is less than the first ratio N1. Accordingly, the third distance d3 is less than the second distance d2 illustrated in FIG. 12A.

Although not shown, when the electronic apparatus 100 receives the punch zoom-in input, the display apparatus 200 may increase the first ratio N1 to a third ratio N3. In this case, a degree to which the first ratio N1 is to be increased may be determined according to a moving distance according to the punch zoom-in input.

Accordingly, when the electronic apparatus 100 receives a drag input for performing dragging by the first distance d1 in the second direction, the display apparatus 200 may move a cursor displayed thereon by a fourth distance d4 corresponding to the first distance d1 in the second direction. A ratio of the fourth distance d4 to the first distance d1 may be the third ratio N3 and the third ratio N3 is greater than the first ratio N1. Thus, the fourth distance is greater than the second distance d2.

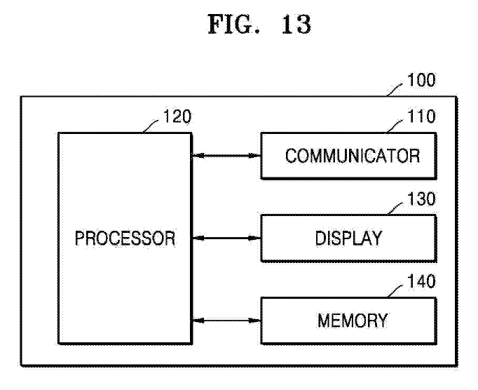

FIG. 13 is a block diagram illustrating an example electronic apparatus 100 according to an example embodiment of the present disclosure.

Referring to FIG. 13, the electronic apparatus 100 according to an embodiment includes a communicator (e.g., including communication circuitry) 110, a processor (e.g., including processing circuitry) 120, a display 130, and a memory 140.

In an example embodiment, the communicator 110 may include various communication circuitry, including, for example, one or more components to establish communication between the electronic apparatus 100 and an external device (e.g., the display apparatus 200 of FIG. 1). For example, the communicator 110 may transmit a connection request message for pairing with the external device to the external device. The communicator 110 may transmit web page information to the external device and receive content information regarding selected web content from the external device through short-range communication. Furthermore, the communicator 110 may transmit a control signal or the like corresponding to a user input received through a control interface provided by the electronic apparatus 100. In this case, examples of the short-range communication may include, for example, and without limitation, a Wi-Fi method, an NFC method, a Bluetooth method, an infrared method, a ZigBee method, or the like, but is not limited thereto.

In an example embodiment, the processor 120 may include various processing circuitry and execute one or more programs stored in the memory 140. The processor 120 may include, for example, and without limitation, a single core, a dual core, a triple core, a quad core, or a multiple core, or the like. Alternatively, the processor 120 may include a plurality of processors. For example, the processor 120 may be embodied as a main processor (not shown), and a sub-processor (not shown) which operates in a sleep mode.

In an example embodiment, the memory 140 may store various types of data, a program, or an application for driving and controlling the electronic apparatus 100.

The program stored in the memory 140 may include one or more instructions. The program (one or more instructions) or the application stored in the memory 140 may be executed by the processor 120.

In an example embodiment, the processor 120 may execute the one or more instructions stored in the memory 140, display an icon corresponding to an external device located within a predetermined distance from the electronic apparatus 100 when the external device is recognized, and control pairing with the external device when the icon is selected.

The processor 120 may determine a control interface corresponding to web content based on content information received from an external device, and control the display 130 to display the determined control interface.

Furthermore, the processor 120 may receive a pinch input, and control a speed of moving a pointer displayed on an external device according to the type and a moving distance of the pinch input.

In an example embodiment, the display 130 may convert an image signal, a data signal, an on-screen display (OSD) signal, a control signal, or the like processed by the processor 120 into a driving signal.

The display 130 may be embodied as a plasma display panel (PDP), a liquid crystal display (LCD), an organic light-emitting diode (OLED), a flexible display, or the like, but is not limited thereto. For example, the display 130 may be embodied as a three-dimensional (3D) display. The display 130 may be embodied as a touch screen and may be thus used as an input device, as well as an output device.

In an example embodiment, the display 130 may display a different control interface based on the type of web content. For example, when web content is image content or text content, the display 130 may display a control interface for performing, for example, and without limitation, at least one among displaying the image content or the text content, selecting the image content or the text content, editing the image content or the text content, storing the image content or the text content, and sharing the image content or the text content, or the like. When web content is video content or audio content, the display 130 may display a control interface for performing at least one among reproducing the video content or the audio content, stopping the reproduction of the video content or the audio content, controlling volume of the video content or the audio content, controlling a reproduction speed, and setting a reproduction time. When web content is game content, the display 130 may include at least one key for manipulating the game content and display a game control interface which is set on the basis of the type of the game content or a user input. However, embodiments are not limited thereto.

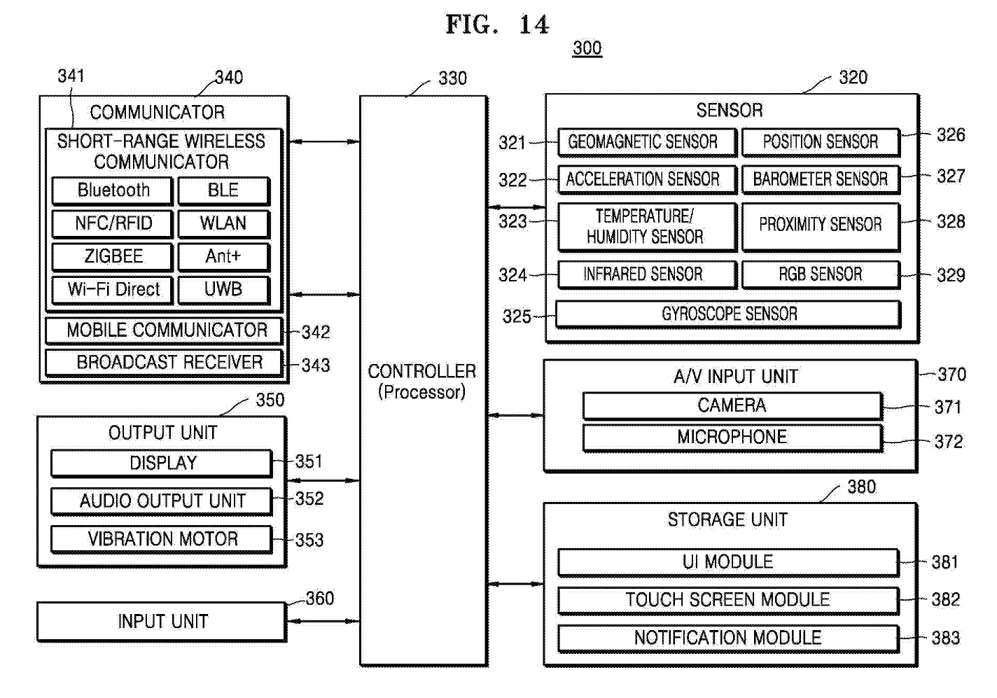

FIG. 14 is a block diagram illustrating an example electronic apparatus 300 according to another example embodiment of the present disclosure. The electronic apparatus 300 of FIG. 14 may be an example embodiment of the electronic apparatus 100 of FIG. 1.

Referring to FIG. 14, the electronic apparatus 300 according to an example embodiment may include a controller (e.g., including processing circuitry) 330, a sensor (e.g., including various sensors and/or sensing circuitry) 320, a communicator (e.g., including communication circuitry) 340, an output unit (e.g., including output circuitry) 350, an input unit (e.g., including input circuitry) 360, an audio/video (A/V) input unit (e.g., including A/V input circuitry) 370, and a storage unit 380.

The communicator 340 of FIG. 14 may correspond to the communicator 110 of FIG. 13. The controller 330 of FIG. 14 may correspond to the processor 120 of FIG. 13. A display 351 of FIG. 14 may correspond to the display 130 of FIG. 13. The storage unit 380 of FIG. 14 may correspond to the memory 140 of FIG. 13. Parts of FIG. 14 which are the same as or similar to those of FIG. 13 are not described again here.

The communicator 340 may include one or more components to establish communication between the electronic apparatus 300 and an external device (e.g., a server or the like). For example, the communicator 340 may include various communication circuitry, such as, for example, and without limitation, a short-range wireless communicator 341, a mobile communicator 342, and a broadcast receiver 343.

Examples of the short-range wireless communicator 341 may include, for example, but are not limited to, a Bluetooth communicator, a near-field communicator, a WLAN (Wi-Fi) communicator, a ZigBee communicator, an infrared data association (IrDA) communicator (not shown), a Wi-Fi direct (WFD) communicator, a ultra-wideband (UWB) communicator, an Ant+communicator, WLAN communication, BLE communicator, or the like.

The mobile communicator 342 may include various mobile communication circuitry and transmits a radio signal to or receives a radio signal from at least one among a base station, an external terminal, and a server in a mobile communication network. Here, the radio signal may include a voice call signal, a video call signal, or various types of data generated when text/multimedia messages are transmitted and received.

The broadcast receiver 343 may include various broadcast receiving circuitry and receives a broadcast signal and/or broadcast-related information from the outside via a broadcast channel. The broadcast channel may include a satellite channel, a terrestrial channel, or the like, but is not limited thereto. In an embodiment, the electronic apparatus 300 may not include the broadcast receiver 343.

The output unit 350 may include various output circuitry and is configured to output an audio signal, a video signal, or a vibration signal, and may include, for example, and without limitation, the display 351, an audio output unit (e.g., including audio output circuitry) 352, a vibration motor 353, or the like.

The audio output unit 352 may include various audio output circuitry and outputs audio data received from the communicator 340 and/or audio data stored in the storage unit 380. Furthermore, the audio output unit 352 outputs an audio signal related to a function performed by the electronic apparatus 300 (e.g., call signal reception sound, message reception sound, or notification sound). The audio output unit 352 may include a speaker, a buzzer, or the like. For example, the audio output unit 352 may output alarm when a recognized user is not an authorized user.

The vibration motor 353 may output a vibration signal. For example, the vibration motor 353 may output a vibration signal corresponding to an output of audio data or video data (e.g., call signal reception sound, message reception sound, or the like). Alternatively, the vibration motor 353 may output a vibration signal when a touch is input to a touch screen.

The controller 330 may include various processing circuitry and controls overall operations of the electronic apparatus 300. For example, the controller 330 may execute programs stored in the storage unit 380 to control the communicator 340, the output unit 350, the user input unit 360, the sensor 320, the A/V input unit 370, or the like.

The input unit 360 may include various input circuitry to input data to control the electronic apparatus 300. Examples of the input unit 360 may include, for example, but are not limited to, a key pad, a dome switch, a touch pad (a touch-type capacitive touch pad, a pressure-type resistive overlay touch pad, an infrared sensor-type touch pad, a surface acoustic wave conduction touch pad, an integration-type tension measurement touch pad, a piezo effect-type touch pad, or the like), a jog wheel, a jog switch, or the like.

The sensor 320 may include various sensing circuitry and/or a sensor which senses a user's bio-information, and a sensor which senses a state of the electronic apparatus 300 or a state of the periphery of the electronic apparatus 300. The sensor 320 may transmit information sensed by the sensor 320 to the controller 320.

The sensor 320 may include, for example, and without limitation, at least one among a geomagnetic sensor 321, an acceleration sensor 322, a temperature/humidity sensor 323, an infrared sensor 324, a gyroscope sensor 325, a position sensor (e.g., a global positioning system (GPS)) 326, a barometer sensor 327, a proximity sensor 328, and an RGB sensor (an illuminance sensor) 329, or the like, but is not limited thereto. Since functions of these sensors would be intuitively inferred from the names of the sensors and are thus not described in detail here.

The A/V input unit 370 may include various A/V input circuitry and may input an audio signal or a video signal and may include a camera 371, a microphone 372, or the like, but is not limited thereto. The camera 371 may obtain a video frame, such as a still image or a moving picture, through an image sensor in a video call mode or a shooting mode. An image captured via the image sensor may be processed by the controller 330 or an additional image processor (not shown).

A video frame processed by the camera 371 may be stored in the storage unit 380 or may be transmitted to the outside via the communicator 340. Two or more cameras 371 may be provided according to an embodiment of the electronic apparatus 300.

The microphone 372 receives an external audio signal and converts the received audio signal into electrical voice data. For example, the microphone 372 may receive an audio signal from an external device or a speaker. The microphone 372 may use various types of noise rejection algorithms to remove noise generated when an external audio signal is received.

The storage unit 380 may store a program for performing processing and controlling by the controller 330, and store input/output data (e.g., an application, content, time zone information with respect to an external device, an address, etc.).

The storage unit 380 may include at least one among a flash memory type storage medium, a hard disk type storage medium, a multimedia card micro type storage medium, a card type memory (e.g., an SD or XD memory), a random access memory (RAM), a static RAM (SRAM), a read-only memory (ROM), an electrically erasable programmable read-only memory (EEPROM), a programmable read-only memory (PROM), a magnetic memory, a magnetic disk, and an optical disc. The electronic apparatus 300 may operate a web storage system or a cloud server which performs a storage function of the storage unit 380 on the Internet.

Programs stored in the storage unit 380 may be classified into a plurality of modules according to functions thereof. For example, the programs may be classified into an UI module 381, a touch screen module 382, a notification module 383, etc.

The UI module 381 may include various circuitry and/or program elements and provide a specialized user interface (UI), a specialized graphical UI (GUI), etc. linked to the electronic apparatus 300 according to applications. The touch screen module 382 may sense a touch gesture on a user's touch screen and transmit information regarding the touch gesture to the controller 130.

The touch screen module 382 may include various touch screen circuitry and recognize and analyze touch code. The touch screen module 382 may be configured as an additional hardware component having a controller.

The notification module 383 may include various notification circuitry and generate a signal notifying generation of an event in the electronic apparatus 300. Examples of an event generated in the electronic apparatus 300 may include reception of a call signal, reception of a message, an input of a key signal, schedule notification, etc. The notification module 383 may output a notification signal in the form of a video signal via the display 351, output a notification signal in the form of an audio signal via the audio output unit 352, or output a notification signal in the form of a vibration signal via the vibration motor 353.

The block diagrams of the electronic apparatuses 100 and 300 illustrated in FIGS. 13 and 14 are merely examples provided to illustrate various example embodiments. The components of the block diagrams may be combined or omitted or new components may be added thereto according to the specifications of the electronic apparatuses 100 and 300 which are actually implemented. That is, two or more components among these components may be combined into one component or one component among these components may be subdivided into two or more components. A function performed by each block in FIGS. 13 and 14 is merely an example provided to explain embodiments. Accordingly, the scope of the present disclosure is not limited by a particular operation of each block or the electronic apparatuses 100 and 300 of, FIGS. 13 and 14.

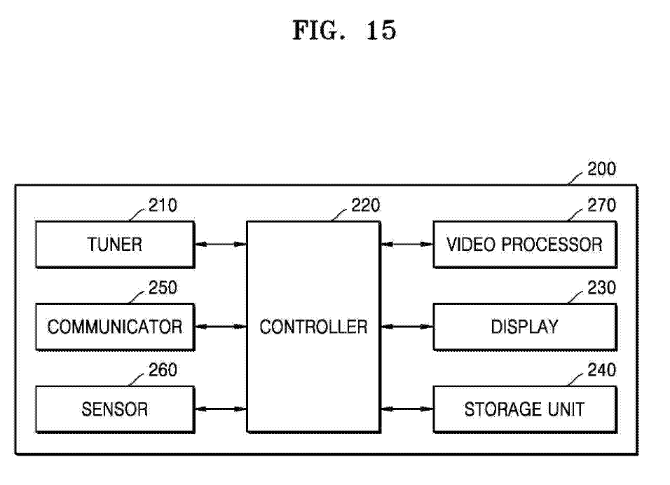

FIG. 15 is a block diagram illustrating an example display apparatus according to an example embodiment of the present disclosure.

Referring to FIG. 15, the display apparatus 200 according to an embodiment may include a tuner 210, a controller (e.g., including processing circuitry) 220, a display 230, a communicator (e.g., including communication circuitry) 250, a sensor 260, a video processor (e.g., including video processing circuitry) 270, and a storage unit 240.

The tuner 210 may include various circuitry and tune and select only a frequency of a channel to be received by the display apparatus 200 among many radio waves by amplifying, mixing, or resonating broadcast signals received via a wire or wirelessly. Examples of the broadcast signal include audio, video, and additional information (e.g., an electronic program guide (EPG)), or the like, but is not limited thereto.

The tuner 210 may include various circuitry and receive a broadcast signal in a frequency band corresponding to a channel number according to a user input (e.g., a control signal received from a control device, such as a channel number input, channel up/down input, or a channel input based on an EPG screen), or the like, but is not limited thereto.

The tuner 210 may receive a broadcast signal from various sources such as a terrestrial broadcast, a cable broadcast, a satellite broadcast, and an Internet broadcast, etc. The tuner 210 may receive a broadcast signal from a source such as an analog broadcast or a digital broadcast.

The communicator 250 may include various communication circuitry and transmit data or a signal to an external device (or server) or receive data or a signal from the external device (or server) under control of the controller 220. The controller 220 may transmit content to or receive content from an external device connected thereto via the communicator 250, download an application from the external device, or perform web browsing. The communicator 250 may transmit or receive data or a signal via at least one among a wireless local area network (LAN) (e.g., Wi-Fi), Bluetooth, and a wired Ethernet according to the performance and structure of the display apparatus 200.

In an example embodiment, the communicator 250 may receive web page information from an external device (e.g., the electronic apparatus 100). The communicator 250 may transmit content information regarding web content to the external device. The communicator 250 may receive a connection request message from the external device and transmit a connection request response message to the external device. Furthermore, the communicator 250 may receive a control signal from the external device.

The video processor 270 may include various video processing circuitry and processes video data received by the display apparatus 200. The video processor 270 may perform various types of processing, such as decoding, scaling, noise filtering, frame rate conversion, resolution conversion, or the like, on the video data.

The sensor 260 may receive an optical signal (including a control signal) from an external control device via a wide window (not shown) of a bezel of the display 220 or the like. The sensor 260 may receive an optical signal corresponding to a user input (e.g., touching, pressing, a touch gesture, voice, or a motion) from the control device. The controller 210 may extract a control signal from the received optical signal. Furthermore, the sensor 260 senses a user's voice, image, or interaction. In one embodiment, the sensor 260 may include a microphone to receive the user's uttered voice. The microphone may convert received voice into an electrical signal and output the electrical signal to the controller 220.

In an example embodiment, the sensor 260 may sense an input and transmit the sensed signal to the controller 220. The sensor 260 may sense a user input related to, for example, channel-up/down, power on/off, channel selection, screen setting, etc. from the electronic apparatus 300 corresponding to the control device. In one embodiment, the sensor 260 may sense an input for pressing a channel-up key or a channel-down key included in the electronic apparatus 300, an input for long pressing the channel-up key or the channel-down key, an input for releasing the channel-up key or the channel-down key, or the like.

The controller 220 may include various processing circuitry andcontrols overall operations of the display apparatus 200, controls a flow of signals between inner components of the display apparatus 200, and performs data processing. When a user input is received or previously set and stored conditions are satisfied, the controller 220 may execute an operating system (OS) and various applications stored in the storage unit 240.

The controller 220 may control the display 230 to display a web page on the basis of web page information received from an external device, and select web content by moving a pointer on the displayed web page according to a control signal received from the external device. Furthermore, the controller 220 may analyze the selected web content and transmit content information including information regarding the type of the web content and data related to the web content to the external device.

The display 230 converts an image signal, a data signal, an OSD signal, or a control signal, etc. processed by the controller 220 into a driving signal. The display 230 may be embodied as a PDP, an LCD, an OLED, a flexible display, or the like and may be a 3D display, but is not limited thereto. Alternatively, the display 130 may be embodied as a touch screen and used as an input device, as well as an output device.

The storage unit 240 may store various types of data, a program, or an application for driving and controlling the display apparatus 200, under control of the controller 220. Although not shown, the storage unit 240 may include a broadcast receiving module, a channel control module, a volume control module, a communication control module, a voice recognition module, a motion recognition module, a light receiving module, a display control module, an audio control module, an external input control module, a power control module, a power control module of an external device connected wirelessly (e.g., via Bluetooth), voice database (DB), or a motion DB. The modules and the databases of the storage unit 240 may be embodied in the form of software to perform in the display apparatus 200 a broadcasting control function, a channel control function, a volume control function, a communication control function, a voice recognition function, a motion recognition function, a light receiving control function, a display control function, an audio control function, an external input control function, a power control function, or a power control function of an external device connected wirelessly (e.g., via Bluetooth). The controller 220 may perform these functions by using the software stored in the storage unit 240.

The block diagram of the display apparatus 200 illustrated in FIG. 15 is a merely example provided to explain an embodiment. The components of the block diagram may be combined or omitted or new components may be added thereto according to the specifications of the display apparatus 200 actually implemented. That is, two or more components among these components may be combined into one component or one component among these components may be subdivided into two or more components if necessary. A function performed by each block in FIG. 15 is merely an example provided to explain embodiments. Accordingly, the scope of the present disclosure is not limited by a particular operation of each block or the display apparatus 200.

In an example embodiment, an electronic apparatus may provide a different control interface based on the type of web content selected by a display apparatus, thereby improving a user's convenience.

In an example embodiment, when a web page, which is displayed on the electronic apparatus, is displayed on the display apparatus, the web page may be displayed based on a layout and a resolution optimized for the display apparatus.

In an example embodiment, when a web page, which a user logs on and which is displayed on the electronic apparatus, is displayed on the display apparatus, a log on state of the user may be maintained and thus an additional log on process regarding the web page is not needed, thereby improving the user's convenience.

In an example embodiment, a method of operating an electronic apparatus may be embodied in the form of program instructions executable using various types of computer means and may be recorded on a non-transitory computer-readable medium. The non-transitory computer-readable medium may store program instructions, data files, data structures, or a combination thereof. The program instructions recorded on this medium may be specially designed and configured for the present disclosure or may be known and available to software engineers in the art. Examples of the non-transitory computer-readable medium include magnetic media such as hard disks, floppy disks and magnetic tapes, optical media such as a CD-ROMs and DVDs, magneto-optical media such as floptical disks, and hardware devices such as ROMs, RAMs, and flash memories which are specially configured to store and execute program instructions. Examples of the program instructions include not only machine language code made by a compiler but also high-level language code executable in a computer using an interpreter or the like.

While various example embodiments have been described in detail above, the scope of the present disclosure is not limited thereto and should be understood to include various changes and alternatives made in the present disclosure by those of ordinary skill in the art based on the basic concepts of the present disclosure as set forth, for example, in the following claims.

What is claimed is:

1. An electronic apparatus comprising:
a display configured to display a web page;
a communicator comprising communication circuitry configured to transmit web page information for displaying the web page to a display apparatus paired with the electronic apparatus;
a memory storing one or more instructions; and
a processor configured to execute the one or more instructions stored in the memory,
wherein the processor is further configured, by executing the one or more instructions, to cause the electronic apparatus to:
receive content information regarding web content selected from the web page displayed on the display apparatus,
determine a control interface corresponding to the web content, based on the content information, and
control the display to display the determined control interface.

2. The electronic apparatus of claim 1, wherein the processor is further configured, by executing the one or more instructions, to cause the electronic apparatus to:
recognize the display apparatus located within a predetermined distance of the electronic apparatus, and
control the display to display a first icon when the display apparatus is recognized.

3. The electronic apparatus of claim 2, wherein the processor is further configured, by executing the one or more instructions, to cause the electronic apparatus to:
perform pairing with the display apparatus when an input for selecting the first icon is received, and
control the web page information to be transmitted to the display apparatus.

4. The electronic apparatus of claim 1, wherein the web page information comprises session information of the web page,
wherein the processor is further configured, by executing the one or more instructions, to cause the electronic apparatus to:
encrypt the session information of the web page, and
control the encrypted session information to be transmitted to the display apparatus.

5. The electronic apparatus of claim 1, wherein the content information comprises information indicating a type of the selected web content,
wherein the processor is further configured, by executing the one or more instructions, to cause the electronic apparatus to determine the control interface corresponding to the web content, based on the type of the web content.

6. The electronic apparatus of claim 1, wherein the web content comprises at least one of: image content, text content, video content, audio content, and game content.

7. The electronic apparatus of claim 1, wherein, when the web content comprises image content and/or text content, and the processor is further configured, by executing the one or more instructions, to cause the electronic apparatus to control the display to display the web content and to display a control interface for performing at least one of: selecting the web content, editing the web content, storing the web content, and sharing the web content.

8. The electronic apparatus of claim 1, wherein, when the web content comprises video content and/or audio content, and the processor is further configured, by executing the one or more instructions, to cause the electronic apparatus to control the display to display a control interface for performing at least one of: reproducing the web content, stopping the reproducing of the web content, volume control, reproduction speed control, and reproduction time control.

9. The electronic apparatus of claim 1, wherein, when the web content comprises game content, and the processor is further configured, by executing the one or more instructions, to cause the electronic apparatus to control the display to display a game control interface including at least one key for manipulating the game content, the game control interface being set based on a type of the game content and/or an input.

10. The electronic apparatus of claim 1, wherein, when an input window is selected on the web page, the processor is further configured, by executing the one or more instructions, to cause the electronic apparatus to control the display to display a character input interface.

11. The electronic apparatus of claim 1, wherein, when an input for selecting a tab key included in the control interface and an input for selecting a type of web content are received, the processor is further configured, by executing the one or more instructions, to cause the electronic apparatus to control a focus displayed on the display apparatus to be moved between types of web content corresponding to the selected type of web content.

12. The electronic apparatus of claim 1, wherein the processor is further configured, by executing the one or more instructions, to cause the electronic apparatus to:
receive a pinch input, and
control a speed of movement of a pointer displayed on the display apparatus based on a type of the pinch input and a moving distance of the pinch input.

13. A method of operating an electronic apparatus, the method comprising:
displaying a web page;
transmitting web page information for displaying the web page to a display apparatus paired with the electronic apparatus;
receiving content information of web content selected from the web page displayed on the display apparatus; and
determining and displaying a control interface corresponding to the web content, based on the content information.

14. The method of claim 13, further comprising:
displaying a first icon when the display apparatus located within a predetermined distance of the electronic apparatus is recognized; and
performing pairing with the display apparatus when an input selecting the first icon is received.

15. The method of claim 13, wherein the web page information comprises session information of the web page, and
the method further comprises encrypting the session information of the web page,
wherein the transmitting of the web page information comprises transmitting the encrypted session information to the display apparatus.

16. The method of claim 13, wherein the content information comprises information indicating a type of the selected web content,
wherein the determining of the control interface comprises determining the control interface corresponding to the web content, based on the type of the web content.

17. The method of claim 13, wherein, when the web content is image content and/or text content, the displaying of the control interface comprises displaying the web content, and displaying a control interface for performing at least one of:
selecting the web content, editing the web content, storing the web content, and sharing the web content.

18. The method of claim 13, wherein, when the web content is video content and/or audio content, the displaying of the control interface comprises displaying a control interface for performing at least one of: reproducing the web content, stopping the reproducing of the web content, volume control, reproduction speed control, and reproduction time control.

19. The method of claim 13, wherein, when the web content is game content, the displaying of the control interface comprises displaying a game control interface including at least one key for manipulating the game content, the game control interface being set based on a type of the game content and/or an input.

20. A non-transitory computer-readable recording medium having recorded thereon a program for performing the method of claim 13 on a computer.
